(19) United States
(12) Patent Application Publication
(10) Pub. No.: US 2024/0051242 A1
(43) Pub. Date: Feb. 15, 2024

(54) COMPUTER-AIDED PROCESS PLANNING (CAPP) FOR AUTOMATED FIBER PLACEMENT (AFP) MANUFACTURING

(71) Applicant: UNIVERSITY OF SOUTH CAROLINA, Columbia, SC (US)

(72) Inventors: Ramy HARIK, Columbia, SC (US); Joshua HALBRITTER, Columbia, SC (US); Alex BRASINGTON, Columbia, SC (US)

(21) Appl. No.: 18/366,049

(22) Filed: Aug. 7, 2023

Related U.S. Application Data
(60) Provisional application No. 63/415,370, filed on Oct. 12, 2022.
(60) Provisional application No. 63/396,278, filed on Aug. 9, 2022.

(51) Int. Cl. B29C 70/38; G06F 30/20

(52) U.S. Cl. CPC B29C 70/382; G06F 30/20; G06F 2113/26

(57) ABSTRACT

Automated Fiber Placement (AFP) manufacturing with carbon fiber composites is increasingly used for complex and/or large structures. Computer-Aided Process Planning (CAPP) software supports process planning for AFP manufacturing to assist identifying optimal starting point location and layup strategy for each laminate ply. Ply optimization functions on measurement and scoring of geometry-based defects (gaps, overlaps, angle deviation, and steering). CAPP mitigates defect stacking through the laminate thickness by generating best ply scenarios and comparing ply defects to identify regions where defects are stacking up. Stacked defects frequency and severity are described using a disclosed scoring system, so process planners can craft fiber paths that mitigate the number and compounding effect of laminate geometry-based defects. Defects can be minimized in the process planning phase by optimizing the selection of input parameters such as starting points, layup strategies, and tows per course, using surrogate-based methods.

### PRIORITY CLAIM

The present application claims the benefit of priority of U.S. Provisional Patent Application No. 63/396,278, titled COMPUTER-AIDED PROCESS PLANNING SOFTWARE, filed Aug. 9, 2022, and claims the benefit of priority of U.S. Provisional Patent Application No. 63/415,370, titled COMPUTER-AIDED PROCESS PLANNING (CAPP) FOR AUTOMATED FIBER PLACEMENT (AFP) MANUFACTURING, filed Oct. 12, 2022, both of which are fully incorporated herein by reference and for all purposes.

### STATEMENT REGARDING SPONSORED RESEARCH OR DEVELOPMENT

This invention was made with Government support under Grant No. 24486 and Grant No. 10010906, both awarded by NASA. The Government has certain rights in the invention.

### BACKGROUND OF THE PRESENTLY DISCLOSED SUBJECT MATTER

### 1. Introduction

The disclosure deals with systems and/or methodology related to Automated Fiber Placement (AFP) manufacturing. AFP manufacturing with carbon fiber composites is increasingly popular in manufacturing sectors, leading to the possibility of increasingly complex and/or large structures. Computer-Aided Process Planning (CAPP) software supports process planning for AFP manufacturing to assist process planners in identifying optimal starting point location and layup strategy for each ply of the laminate. The ply optimization functions on the measurement and scoring of geometry-based defects such as gaps, overlaps, angle deviation, and steering. CAPP in one facet focuses on mitigating defect stacking through the thickness of the laminate, by generating laminate scenarios from the best ply scenarios and comparing the defects of each ply through the thickness to identify regions where defects are stacking on top of each other. The frequency and severity of stacked defects are then described using a novel scoring system. Defects can be minimized in the process planning phase by optimizing the selection of input parameters such as starting points, layup strategies, and tows per course, using surrogate-based methods. Examples are explained in conjunction with doubly curved tool surface and struts regarding aerospace industry utilization.

Automated fiber placement (AFP) is an advanced technique for manufacturing composite structures using robotic arms or gantry systems coupled with a fiber placement head to heat and compact strips of (usually) pre-impregnated fibers called tows. These tows are laid out on a tool surface in groups called courses until the desired shape is reached, constituting a single ply. This process is repeated, laying up ply by ply until the full laminate is created. Due to interactions between the axial stiffness of fibers within the tows, underlying tool surface geometry for the parts being created with AFP, and limitations of the process, a variety of fiber defects are likely to occur during the placement of material^{[1]}.

The most common defects related to tow geometry are gaps, overlaps, and wrinkles which have been investigated at length over the past several years. Sawicki et al. found that laminates containing overlaps and gaps saw strength reductions upwards of 27% and deduced that out-of-plane waviness was the main cause of this reduction^{[2]}. Other defects include pucker, bridging, angle deviation, steering, fold, twist, wandering tow, loose tow, missing tow, position error, and foreign object. Harik et al. describes the cause, anticipation, existence, significance, and progression of these defects summarizing some of their effects on individual plies and the overall laminate^{[}1,2]. Additionally, due to the laminated nature of composite structures, defects can interact with each other through the thickness of the laminate. Therefore, the identification and evaluation of stacked defects can further improve the resulting composite structures manufactured through AFP.

Automated Fiber Placement (AFP) is a composite manufacturing technique that was developed in the 1980s and 1990s. The AFP process consists of a gantry/robotic system with an attached fiber placement head. This head enables multiple strips of composite material, or tows, to be laid onto a tool surface. Adhesion between the incoming tows and substrate is ensured by using appropriate process conditions such as heating, compaction, and tow tension. A series of tows forms a course, courses are then combined to create a ply, and multiple plies create a laminate.

AFP is commonly used to manufacture large aerospace structures such as fuselages and wing skins, however recent advancements have provided a pathway for manufacturing smaller and more complex parts. These complex parts can increase the occurrence of defects, leading to detrimental effects on the final laminate. The main defects that are considered in an industry setting are gaps, overlaps, angle deviation, and steering. These defects with their causes and effects have been summarized in Table 1 below^{[1]}. Further causes of such defect types have also been discussed in prior cases^{[14]}.

TABLE 1
Common AFP defects with their causes and significance ^{[1]}

| Defect | Causes | Significance |
|---|---|---|
| Gap/ | Fiber steering, Layup over | Site for failure initiation, Resin |
| Overlap | complex surfaces | rich areas, Site for wrinkling |
| Angle | Incorrect roller coverage, | Causes overlaps, Leads to resin |
| Deviation | Small steering radii | rich areas |
| Steering | Complex surfaces, | Causes angle deviations, fiber |
| | changing curvatures | wrinkling, steering defects |

Automated Fiber Placement (AFP) is increasingly utilized for manufacturing composite materials into useful parts^{[28]}. An AFP machine is typically comprised of a robotic arm/gantry and a fiber placement head that can layup multiple strips of fiber reinforced polymer-matrix material. These strips primarily use a carbon fiber material and are known as tows. Groups of tows, known as courses, are laid up in differently oriented layers, known as plies, to increase the strength and isotropy of the part^{[5]}. To secure adhesion of these tows, the fiber placement head must have a method of heating the resin and compacting it down to the surface. This process is accomplished by using a controlled amount of heat and compaction load supplied by the AFP end-effector^{[√]}. After placing the first ply on the tool surface, subsequent plies can be added until the desired thickness and strength of the part has been achieved.

During the manufacturing process, fiber defects may occur, which represent a disparity between the intended laminate design and the manufactured structure. To understand AFP defects, the source of the defect and how the part geometry influences the defect formation must be explored. A subset of these defects can be predicted and modeled through the interaction of the tool surface geometry and the fiber tows alone, while others may occur due to manufacturing conditions, machine errors, or material quality. The ability to model some of these defects enables an entire virtual layup to be built and analyzed before any manufacturing, so that those defects can be preemptively mitigated. These fiber defects can occur due to fluctuations of processing parameters such as heating and compaction, environmental factors such as temperature and humidity, or inaccurate predictions of the material's behavior that result in deviations from expected fiber placement paths.

Common defect types include tow gaps and overlaps, along with fiber steering (FIG. 1). When manufacturing laminates with complex surface geometries, fiber tows can no longer be placed in straight, parallel rows without excessive deformation of the tow itself. Due to the high modulus of elasticity of carbon fiber, it becomes necessary to rely on in-plane curvature of the tow placement to minimize the overall deformation of the material. This in-plane curvature is known as fiber steering, and excessive steering can induce such defects as puckers, wrinkles, folds and twists. These resultant defects consist of out of plane deformation of the tows to reduce stresses generated from steering. Additionally, concessions must be made for the alignment of courses on complex surfaces, resulting in gaps and overlaps. A gap occurs when two adjacent tows are not perfectly laid up adjacent to each other resulting in a gap between the tows. An overlap is when the two adjacent tows are overlapping onto each other.

The prediction of defects through virtual layup, along with robust automated inspection paired with manual rework represent an efficient route for the reduction of defect occurrences and overall impact on the strength of the final composite structure^{[6] [4] [8]}. Before the presentation of our case study, we begin with a description of the manufacturing parameters and methods used for the prediction and detection of the relevant fiber defects. The case study describes the prediction and inspection results along with a comparison of the two sets of results. Finishing with concluding remarks on the performance of defect detection and comparison along with plans for further developing the capabilities presented here.

The best way to prevent defects on a given surface is to spend significant time process planning. This consists of an iterative cycle of choosing starting points, layup strategies, and other options until the manufacturer is content with the results. With simple (mostly flat) surfaces, this process is not as crucial since limited defects are expected. However, choosing starting points and layup strategies for complex surfaces can have a massive impact on defect generation and final part quality. Manually searching for an optimal starting point can be a difficult process that is very time consuming. The change in defect generation from one starting point or layup strategy to another is also a difficult concept to predict. Various combinations can also have many local optimums adding to the difficulty of finding the global optimum inputs. Therefore, an optimization technique is needed to efficiently search the surface without getting trapped in local optimums. This type of problem lends itself well to surrogate modeling optimization techniques. These algorithms are known to be able to search a design space and capture local optimums along with finding global optimums. These optimizations are accomplished through the Computer-Aided Process Planning (CAPP) software and its connection with VERICUT®® Composite Programming (VCP)^{[2] [12]}.

The remaining content of the disclosure will be as follows. Section 1.1 and 1.2 will review the process planning portion of the AFP process. Section 2 will present a background on surrogate modeling and the techniques to be used in the latter. In Section 3, the methods for defect analysis and the objective function used for the optimization will be established. The results and discussion of the optimization will then be presented in Section 4. Lastly, Section 5 will conclude and present future work.

### 1.1 Fiber Defects and Stacking and Process Planning

Through thickness fiber defect interactions are highly complex and their effects largely depend on a number of factors including type of defects stacked, number of intermediate plies, process parameters, tool surface geometry, hard vs soft tooling, etc. Li et al. created 3D meshing tools to automatically generate plies with gaps and overlaps, combined to model full laminates with stacked defects. These models showed the effect of stacked overlaps and gaps on out-of-plane waviness and ply thickness and were used to predict overall strength knockdowns as a function of size and type of defect^{[3]}. Lan et al. studied the impact of hard and soft tooling on thickness variation and mechanical performance for laminates with stacked gaps and overlaps. They found that severely stacked laminates have large variations in overall thickness, specifically when cured without caul plates, and that the use of caul plates mitigates many of the negative impacts of stacked defects on mechanical performance^{[4]}. Croft et al. investigated the impact of gap, overlap, gap/overlap, and twisted tow defects on ultimate strength at the lamina and laminate level. It was discovered that defects have a much larger effect on ultimate strength on the laminate level (up to 13%) than on the lamina level (˜5%)^{[5]}. These disclosures highlight the importance and complexity of studying defect interactions through the thickness of a laminate. This disclosure will present a process planning strategy for mitigating gap and overlap defect stacking leading to a more uniform through-thickness laminate with more predictable mechanical properties.

In its essence, AFP is an automated process controlled by numerical control (NC) code to define the various actions performed by the machine. Therefore, a connection must be made between the designed composite part, and the actions necessary to manufacture it with AFP. This connection is referred to as process planning and is one of the four pillars of the AFP process (design, process planning, manufacturing, inspection)^{[15]}. The process planning pillar is one of the most user-intensive portions where a process planner must use their knowledge of the part and the available resources to translate a design into an AFP manufacturing plan. If not done properly, the resulting manufacturing plan can lead to a part that is not within specifications of the designed part along with increases in labor and material costs. Hence, process planning is a vital aspect in achieving a high-quality final part both structurally and economically. The following will describe the functions that are involved in process planning and their purpose^{[15]}.

### 1.2 Effects on Structural Properties and Layup Strategies

Literature has thoroughly investigated the effects of gaps and overlaps on structural properties within composite laminates. Fayazbakhsh et al. created a finite element (FE) defect layer model to investigate the effect of gaps and overlaps on elastic properties. They found that in variable stiffness laminates, gaps reduced buckling load by 15% while a complete overlap strategy increased buckling load by up to 71%^{[6]}. Blom et al. investigated the impact of tow-drop areas (gaps) on strength and stiffness in variable stiffness laminates. They determined that staggering plies, shifting them by a factor of the course width based on number of like plies, resulted in an increase in strength varying from 3-29% based on tow width and fiber angle distribution^{[7]}. This allows for significantly lower structural allowable in preliminary design and a delay in virtual testing until the detailed design phase.

Layup strategies are methods for defining tool paths to be performed by the AFP machine to achieve the desired shape and structural properties of the final part. For AFP, these strategies utilize a fiber angle and properties of the material to generate the paths. Each strategy uses different geometrical concepts and results in unique solutions dependent on the geometry of the tool surface. This Section will define the various techniques that are used in defining and propagating curves to cover a surface.

### 1B.2.1 Reference Curves

Before propagation of fiber paths across a tool surface can be performed, an initial or refence curve is needed. The chosen method can greatly influence the outcome of the complete layup. The main methods for generating reference curves are fixed angle, geodesic, and variable angle. The following will provide a brief description of

each strategy, while prior art outlines a detailed review^{[13]}. A fixed angle strategy creates a curve from a given starting point that has a constant angle from a given axis or direction along the entire surface. The geodesic curve method can be used to avoid steering because the curvature along a geodesic path is null. A geodesic is the shortest possible line between two points on a curved surface. The path can be obtained either by specifying a start point and a direction of travel or a start and end point on the surface and the curve will follow the natural path of the surface. Variable angle guide curves vary the fiber orientation along the curve to create variable stiffness laminates. There are three main strategies for defining these reference curves: 1) constant curvature, 2) linear variation, and 3) nonlinear variation.

### 1B.2.2 Starting Points

When generating a reference curve, a starting point is needed to define where the reference curve should start. The chosen layup strategy then propagates from this point to create the path. Depending on the placement of the starting point, the resulting reference curve and propagated curves can have large variations. These variations may lead to defects such as overlaps and angle deviations resulting in differing properties when compared with the designed part. When dealing with a predefined reference curve, or guide curve, the starting point defines the location of the first course. The guide curve is then interpolated to this location on the surface to generate the path. Careful considerations should be taken when choosing starting points to ensure that unnecessary defects are not produced.

### 1B.2.3 Coverage Strategies

Once a reference curve is established, there are several ways to propagate the curve to fill the tool surface. There are three strategies that can be used, those being independent curves, offset curves, and shifted curves. The independent curve strategy uses independently drawn curves to cover the surface and is often used on highly complex surfaces to properly cover the surface. The offset method, or sometimes referred to as parallel method, propagates the curve by computing parallel curves that are equidistant from the previous curve. Lastly, the shifted curve method simply shifts the reference curve by applying a perpendicular translation.

### 1.3 Computed-Aided Process Planning (CAPP) Software and Ply Defects

In order to produce composite structures with AFP technology, process planning creates an AFP manufacturing plan based on the working material, composite design, and manufacturing resources. Process planning plays a critical role in the transition from composite design to AFP manufacturing but remains highly user interactive and demands a high degree of domain specific knowledge to progress efficiently and create robust manufacturing strategies.

The Computed-Aided Process Planning (CAPP) software has been developed by our team to begin filling these gaps and assist during process planning^{[2]}. CAPP implements a down selection process of fiber placement strategies and seed points in order to independently generate optimized plies for a composite structure. The selection strategy relies on the prediction and evaluation of the geometrically defined fiber defects, including fiber gaps, overlaps, angle deviation, and degree of steering. CAPP performs an iterative optimization of ply geometry as a function of the placement strategy and seed point, where the ply quantification depends on the resulting fiber defects.

The initial development of CAPP has been focused on ply-based optimization. However, the interaction of defects between individual plies through the thickness of the laminate presents an additional optimization domain which can further reduce the impact of fiber defects and improve the quality of AFP manufactured structures. The following Sections present the terminology which will be used throughout the document, the development and functionality of the CAPP's laminate optimization module, and a virtual case study utilizing the new module for the optimization of fiber defects through the thickness of a composite structure.

### 1.3.1 Ply and Laminate Scenario

CAPP optimization begins with a laminate skeleton, which defines ply boundaries and associated fiber angles. These represent the most basic parameters which may be generated through a structural design software for composite structures. Ply scenarios represent different combinations of process planning variables which relate to the generation of individual fiber paths, namely layup strategy and seed point. Evaluation of these ply scenarios is determined by the resulting geometrically predicted fiber defects during the calculation of fiber paths.

Similarly, laminate scenarios are used for the extension of CAPP to full laminate-based defect interaction optimizations. A laminate scenario is a collection of ply scenarios. The ply scenarios carry over starting point location, path geometry, and the subsequent predicted defect geometry. Additionally, the individual ply scores calculated during the ply optimization process can be utilized to create a ply summary score, describing the average quality of the collection of ply scenarios forming the laminate scenario. The next step is the evaluation of the laminate scenarios as a function of defect interactions from the individual plies.

### 1.3.2 Defect Interaction and Levels

The focus of the disclosure presented in this disclosure is on defect interaction through the thickness of a laminate. To quantify the extent of defect interaction, or more plainly defect stacking, the concept of levels is used. Level 0 corresponds to the area(s) of the tool surface that sees only one defect through the depth of the laminate. Level 1 corresponds to the area(s) of the surface that have two defects stacked upon each other through the thickness of the laminate. Level 2 is three defects and so on and so forth. Currently, this disclosure looks at the defects for all plies globally and projects them onto the same tool surface. Defects are also compared independently, meaning gaps are compared to gaps and overlaps to overlaps.

### SUMMARY OF THE PRESENTLY DISCLOSED SUBJECT MATTER

The presently disclosed computer system and corresponding and/or associated computer methodology deals with systems and/or methodology related to AFP manufacturing.

One presently disclosed object for some embodiments relates to minimizing through thickness defect stack-up for automated fiber placement of composite laminates via fiber path optimization. Another presently disclosed object for some embodiments relates to surrogate-based methods for rapid starting point optimization in automated fiber placement. Yet another relates to parametric analysis of manufacturing composite struts with automated fiber placement. In such regard, presently disclosed subject matter generally relates in some instances to automated fiber placement, process planning, designs for manufacturing, designs for manufacturing struts, optimization including defect optimization, and inspection.

As the world of automated composites manufacturing continues to mature, AFP is proving to be a standout option for the manufacturing of large and complex structures. However, even with the recent advances in the AFP process, unavoidable defects still occur because of tool surface geometry, placement errors, or poor process planning. Defects can be minimized in the process planning phase by optimizing the selection of input parameters such as starting points, layup strategies, and tows per course. This input selection is typically done by hand with a seemingly infinite number of possibilities when considering all possible combinations of inputs, combined with expensive computational costs and a “black box” evaluation function.

Such an optimization problem lends itself to the use of surrogate-based methods. The presented research evaluates multiple surrogate models for ply-by-ply starting point and layup strategy optimization. Each of the models' performances are summarized, along with demonstrating the rapid nature of such an optimization technique when compared with other gradient-free options. Selected methods are used to optimize ply angles of 0°, 45°, −45°, and 90° on a doubly curved surface to evaluate the results of the optimization.

The utilization of advanced composites has been commonplace in the aerospace industry for many years due to their enhanced properties over generic materials. However, manufacturing of composite structures, especially large structures, continues to be challenging. A growing composite manufacturing technique for large aerospace structures is AFP. Due to the increased performance and reliability of the AFP process, it has been rapidly advancing towards use on increasingly complex structures. However, these complex structures bring about their own issues, mainly the resulting unavoidable defects. These consequences can have adverse effects on the local and global laminate properties. Recent research has included predictions on the occurrence of these defects. The predictions have allowed for optimization of the process to minimize defects. Although the predictions are considered to be adequate, it is rare that they are validated with the actual manufacturing results. This disclosure aims to compare these predictions and simulations to real-world manufacturing results to examine their accuracy and validity leading to more integrated predictive capabilities. This is accomplished with the CAPP software, which is used to perform process planning on a doubly curved tool to create tool paths and extract the predicted defects. Inspection results of the manufactured plies are then imported for comparison between predicted and actual defects.

Other example aspects of the present disclosure are directed to systems, apparatus, tangible, non-transitory computer-readable media, user interfaces, memory devices, and electronic smart devices or the like. To implement methodology and technology herewith, one or more processors may be provided, programmed to perform the steps and functions as called for by the presently disclosed subject matter, as will be understood by those of ordinary skill in the art.

In one exemplary embodiment disclosed herewith, methodology for process planning for AFP manufacturing for identifying optimal starting point location and layup strategy for each ply of a subject laminate, for producing complex structures and large structures is disclosed. Such methodology preferably may comprise providing one or more processors programmed for conducting CAPP, wherein such one or more processors are programmed for iteratively determining: (1) a plurality of ply scenarios by locating respective starting points and associated layup strategies and subsequently presenting resulting geometrical fiber defect instances and severity measurements; (2) defining the relative importance of defect types to create an overall ranking of the defect set that is used for ply level optimization; and (3) determining final scores for each ply scenario, so that ply level defects are combined to determine optimal laminate construction that reduces the buildup of defects through the thickness of the laminate.

It is to be understood that the presently disclosed subject matter equally relates to associated and/or corresponding methodologies. One exemplary such method relates to a down selection process of fiber placement strategies and seed points for AFP manufacturing in order to independently generate optimized plies to be used together for a composite structure to be AFP manufactured. Such process preferably may comprise evaluating and predicting geometrically defined fiber defects of a plurality of possible ply geometries for use in the composite structure; and performing an iterative optimization of the possible respective ply geometries as a function of the placement strategy and seed point, where the optimization minimizes impact of resulting fiber defects in the composite structure.

Yet another exemplary such method in accordance with presently disclosed subject matter relates to process planning methodology for Automated Fiber Placement (AFP) for mitigating gap and overlap defect stacking for resulting uniform through-thickness laminate, such methodology preferably comprising providing one or more processors programmed for using surrogate modeling optimization to search a ply level design space and capture local ply level optimums for a planned laminate; and conducting Computer-Aided Process Planning (CAPP), for iteratively determining stacked ply level optimums.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized Section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 illustrates common defect types with fiber steering including wrinkle, pucker, fold, gap and overlap pairs, and twist;

FIGS. 2A and 2B illustrate VERICUT® Composite Programming (VCP) analysis as 3D models in Standard for the Exchange of Product Data (STEP) files formatted as course-to-course overlaps defining each gap and overlap instance as a unique closed contour, where fiber angle deviation and steering are defined on a regular grid over the tool surface;

FIG. 2C represents implementation of surrogate-based optimization (SBO) methodology carried out on a doubly curved tool surface, with ply boundary and example starting point defined;

FIG. 3A illustrates a defect projection of 3-dimensonal entities relative to a non-uniform rational b-splines (NURBS) surface;

FIG. 3B illustrates the subject matter of FIG. 3A projected onto the tool surface obtaining their 2-dimensional representations in the tool surface's parametric domain, with the parametric domain then subdivided into a regular rectangular grid for a discretization step so that the area enclosed within the projected defect polygon is then mapped to a rectangular grid;

FIG. 3C illustrates the final discretized defects represented through the on/off cells within the grid, relative to the subject matter of FIGS. 3A and 3B;

FIG. 4 illustrates stacking of defects relative to the thickness of a laminate, illustrating evolution of a defect level with increasing ply count;

FIG. 5 illustrates a representative complex tool surface with boundary and fiber angle rosette illustration;

FIG. 6A illustrates an of the ply level scenarios for a 10-ply laminate scenario;

FIG. 6B illustrates an enlarged image from FIG. 6A to highlight the stacking of defects that occur between plies;

FIG. 7 illustrates application of the discretized levels back to an original tool surface and allows for an undistorted view of the defects which occurred during the mapping to the parametric domain;

FIG. 8 graphically illustrates for 10 plies the level value trends for each of the laminate scenarios groups, beginning from level 0 to level 5, such that a total of 6 defects have been stacked at some regions within the laminate;

FIG. 9A illustrates the best average scores (group 2) from overlap defect levels sample from randomized laminate scenario sets;

FIG. 9B illustrates the lowest average scores (group 1) relative to FIG. 9A from overlap defect levels sample from randomized laminate scenario sets, in order for the results of the scoring methods to be used to determine the relative best and worst laminate scenario combinations from the group;

FIG. 10 graphically illustrates for 20 plies the level value trends for each of the laminate scenarios groups, beginning from level 0 to level 5, such that a total of 6 defects have been stacked at some regions within the laminate;

FIG. 11A illustrates the best average scores (group 4) from overlap defect levels sample from randomized laminate scenario sets;

FIG. 11B illustrates the lowest average scores (group 1) relative to FIG. 11A from overlap defect levels sample from randomized laminate scenario sets, in order for the results of the scoring methods to be used to determine the relative best and worst laminate scenario combinations from the group;

FIGS. 12A and 12B illustrate, respectively, the evaluation of the performance of the surrogate-based optimization (SBO) and the various regression models, per the two functions defined by Equation 4 (sphere function) and Equation 5 (Griewank function), respectively;

FIGS. 12C and 12D graphically illustrate, respectively, the comparison of each optimization method's optimality, or difference between current and actual best solution, per the two functions defined by Equation 4 (sphere function) and Equation 5 (Griewank function), respectively;

FIG. 13A illustrates an example overlap defect shown VERICUT® Composite Programming (VCP), while FIG. 13B illustrates the resulting bounding polygon extracted through the presently disclosed Computer-Aided Process Planning (CAPP) technology;

FIG. 14A represents an example angle deviation analysis where the deviations are shown in a heat-map within VCP;

FIG. 14B illustrates discrete point values of the FIG. 14A subject matter extracted through the presently disclosed CAPP technology;

FIG. 15 in chart form illustrates an Analytical Hierarchy Process (AHP) matrix with all values set to unity;

FIGS. 16A and 16B graphically illustrate, respectively, all results (16A) and the best-found starting point (16B) for the gap/overlap optimization;

FIGS. 17A and 17B graphically illustrate, respectively, all results (17A) and the best-found starting point (17B) for the angle deviation optimization;

FIGS. 18A and 18B graphically illustrate, respectively, all results (18A) and the best-found starting point (18B) for the combined optimization;

FIGS. 19A through 19D respectively illustrate tradeoffs between defects prior to (FIGS. 19A and 19B) and after (FIGS. 19C and 19D) gap/overlap optimization;

FIG. 20 illustrates defects identified through inspection and mapped onto tool surface, with data for the defect representations and tool geometry resulting in mapping of the defects in scan images back to their original locations on the tool;

FIG. 21 illustrates a projection of surface defects, where defect predictions and inspection results are returned as boundaries and faces along the tool surface, illustrated through a coordinate transformation from cartesian space to parametric u/v space (pixels system);

FIGS. 22A and 22B represent a tool surface with a description of process planning information, and with a resulting manufactured 0° ply, respectively;

FIGS. 23A and 23B are similar to FIGS. 22A and 22B but instead provide VCP analysis showing overlaps, exist between the neighboring courses, alternatingly depicted in white and gray (FIG. 23A), and showing fiber angle deviations depicted on a continuous spectrum, from little-to-no deviation to 3-4° of fiber angle deviation (FIG. 23B);

FIG. 24 illustrates images of the pixelated defects of each type found during processing of inspection data;

FIG. 25 illustrates comparisons of predicted and actual overlaps;

FIG. 26 illustrates comparisons of predicted and actual overlaps combined with surface curvature;

FIG. 27 illustrates an example of a potential embodiment of a lunar lander comprising a Human Landing System;

FIG. 28 illustrates a representative diagram of a typical strut geometry;

FIG. 29 illustrates a representative diagram of strut transition geometries with subject design variables labeled;

FIG. 30 illustrates a representative diagram of strut transition geometries with subject design variables defined;

FIG. 31 graphically illustrates a plot of ratio values for various transition lengths;

FIG. 32 graphically illustrates a plot showing the effect of variables S and L on the ratios;

FIG. 33 graphically illustrates a plot showing the effect of tows per course on the ratio;

FIGS. 34A, 34B, and 34C illustrate, respectively, examples of the steps of the CAPP process, including surface splitting (34A), HKS calculation (34B), and starting point creation (34C), respectively;

FIG. 35 represents user selection of layup strategies;

FIGS. 36A, 36B, 36C, and 36D graphically illustrate, respectively, histogram representations of gaps (36A), overlaps (36B), angle deviation (36C), and steering defects (34D), respectively;

FIG. 37 graphically illustrates a feature threshold chart;

FIG. 38 graphically illustrates in tabulated form an analytic hierarchy process (AHP) matrix, to calculate a single score that combines instance and severity of each defect, in order to rank each set of defects based on their importance;

FIG. 39 represents exemplary user dialogs for creating strut surface and stacking sequence;

FIG. 40 represents a graphical description of how the strut surface and boundaries are created;

FIG. 41 represents the exemplary CAD output of the design tool;

FIG. 42 is a graphical representation of the strut trial test matrix (where the Rosette Rule was used because other strategies generated errors in VCP);

FIGS. 43A and 43B respectively illustrate in graphical form exemplary transition zone analysis with 4 tows (43A) and 2 tows (43B), respectively;

FIG. 44 graphically illustrates direct comparison of manufacturing with 2 and 4 tows;

FIG. 45 illustrates in bar graphs ply and laminate scores for each trial with 4 tows;

FIG. 46 graphically illustrates trends in laminate scores for the 4 tow trials;

FIG. 47 illustrates in bar graphs ply and laminate scores for each trial with 4 tows;

FIG. 48 graphically illustrates trends in laminate scores for the 2 tow trials;

FIGS. 49A and 49B illustrate defect analysis from VCP for 45° plies of 4 tow (49A) and 2 tow (49B) trials, respectively;

FIG. 50 illustrates a presently disclosed example of selected geometry with the overall best results given certain criteria; and

FIG. 51 diagrammatically illustrates an exemplary embodiment of a presently disclosed closed loop composite product lifecycle management tool.

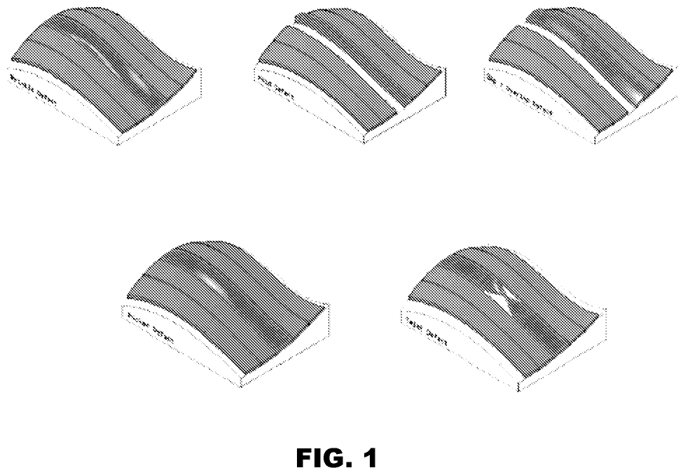

Repeat use of reference characters in the present specification and figures is intended to represent the same or analogous features or elements of the present invention.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to a system which as disclosed is Computer-Aided Processes Planning (CAPP), a software developed to implement and appropriately automate the process planning functions within Automated Fiber Placement (AFP) to aid in the rapid prototyping design phase of composite laminates. This is combined with the ply and laminate level optimization schemes to reduce geometry related fiber defects throughout the laminate. CAPP provides a method for assessing a multitude of inputs to process planning, optimizes said inputs, and provides the manufacturer with the best possible manufacturing plan to produce the structure.

Automated Fiber Placement (AFP) is an additive manufacturing technique using strips of composite material employed in the manufacturing of large aerospace structures. The inherent complexity of the process results in unavoidable defect generation that is largely dependent on the geometry of the structure. Process planning is the matchmaking between a design and manufacturing, and proper planning can help to eliminate many predictable defects. However, this process is currently very manual, complex, and time consuming resulting in bottleneck production issues when trying to get a design to the manufacturing floor.

In order to combat this, CAPP is broken down into three major functions: 1) the software helps to create several ply scenarios by locating starting points with potential layup strategies and subsequently presents the resulting geometrical fiber defect instance and severity measurements using a communication with VERICUT® Composite Programming; 2) the process planner then defines the relative importance of defect types to create an overall ranking of the defect set that is used for the ply level optimization; and 3) final scores are presented for each ply scenario, which is then organized by starting point and the chosen layup strategy. These scores can be used to decide if a satisfactory solution has been reached or if additional iterations should be performed. The ply level defects can then be combined to determine the optimal laminate construction that reduces the buildup of defects through the thickness of the laminate. The method of defect ranking, evaluation, scoring, and optimization is not available in current industry level software products.

The disclosed embodiment can be used for multiple applications. FDP tasks can be used for different types of rotating machinery systems or components, such as bearings, gearboxes, power transformers, etc. These systems are used throughout numerous areas of production and maintenance of equipment, and unfortunately, are prone to problems and failures. For instance, bearings are one of the key components in mechanical systems and bearing faults are the top contributor to the failure of rotating machinery systems, such as wind energy systems, where approximately 80% of gearbox failures are caused by bearing faults.

Moreover, this disclosure is directed mainly toward problem solving in AFP. The process planning phase of Automated Fiber Placement is a time consuming, complex, and highly manual process resulting in a bottleneck to get a design to the manufacturing floor. There are a multitude of interconnected inputs including, but not limited to, layup strategies, starting points, material width, stagger shifts, defect constraints, and defect importance.

The main problem is that current practice is to manually select these inputs, among others, and attempt to assess them without any defined metric. This requires a trial-and-error process, and ply designs are often chosen based on a “first try” solution. This could mean that, for the lifetime of a part, the manufacturing is in a suboptimal condition, resulting in possible material waste, lower throughput, and higher costs.

The anticipated market is the personnel within the Automated Fiber Placement sector. This constitutes roughly 5000 people.

Struts are omnipresent in deployable parts of aircraft and spacecraft. This includes supports for solar panels, lunar lander struts, lunar surface components, strut-based wing components, aircraft spars, or unmanned aerial vehicles^{[32]}. For lunar landers such as the Human Landing System shown in FIG. 27, composites are under consideration to reduce weight of the structure. Unlike general applications of struts, lunar lander struts require greater strength requirements due to high compression load during launch and ascent^{[32]}.

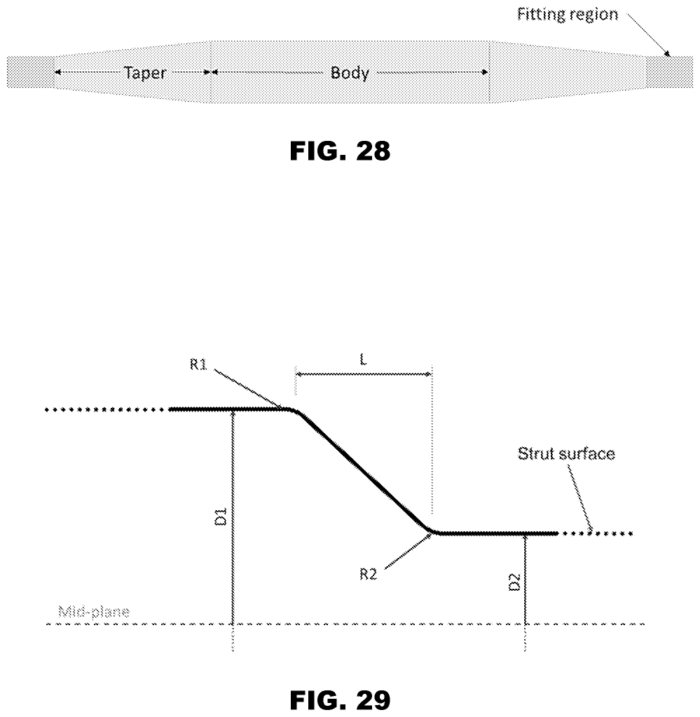

A typical strut geometry is presented in FIG. 28 consisting of a main body, tapered Section, and fitting region. Jegley et al. presents investigations into the efficiency of utilizing composite struts for aerospace applications^{[32]}.

In these studies, Lockheed Martin®^{[34]}, Boeing®^{[35]}, and Northrop Grumman®^{[36]}presented their analysis on the optimum design. A series of strut sizes and stacking sequences were used. The strut geometries varied greatly with various total lengths, untampered lengths, taper angles, and fitting lengths. To provide a general understanding of the strut sizes, Table 9 presents the geometry variations. It was concluded that the carbon-epoxy tapered struts provide a lighter weight alternative to aluminum-lithium alloys for aircraft or spacecraft structures. The geometry still requires an efficient method for manufacturing. Hand layup is a common option for complex geometries, though this is not scalable if a multitude of parts are necessary. For this purpose, the use of Automated Fiber Placement (AFP) is investigated.

TABLE 9
Description of the strut geometries investigated

| Strut | Central | Un-tapered | Taper | Fitting |
|---|---|---|---|---|
| Length | Diameter | Length | Angle | Length |
| (in) | (in) | (in) | (°) | (in) |
| 60.9 | 2.5 | 42.5 | 4 | 2.04 |
| 100.3 | 2.0 | 92.7 | 10 | 1.25 |
| 77.7 | 6.0 | 50.7 | 10 | 2.94 |
| 127.0 | 6.0 | 73.7 | 4 | 2.94 |

AFP is a composite manufacturing technique developed about 30 years ago. This technique utilizes a gantry or robotic system with an attached fiber placement head that enables multiple strips, or tows, to be laid onto a tool surface. AFP has been consistently evolving, manufacturing composite parts with higher speed, repeatability, and improved quality. Flat, low curvature geometries, and cylinders have been the primary areas of research, but AFP in now being used on parts with increasing complexity. This study aims to investigate the manufacturability of landing struts for lunar landers through AFP. Moreover, AFP is also explored for the manufacturing of small and medium parts, versus the traditional large structures. Previously complex parts had to be manufactured through manual lay-up which is a costly and time-consuming process—as well as having accuracy issues—where each composite layer is placed by hand. Although such a process allows for a wider range of applicable surface complexity, it is costly and is not feasible for increased throughput therefore the adaptation of the AFP process is beneficial.

A strut holds several barriers for AFP, one major issue is the geometry of the strut. The strut geometry is unique in that it consists of two different constant radius cylinders connected via a transition zone. This transition zone can be linear or radial and can vary in length as well as the two existing diameters. Dimensional requirements will be based on structural performance and layup quality as found in this study. Layup of complex geometries such as a strut, is a common difficulty in AFP manufacturing due to tow steering which can increase defect formation^{[37],[38]}. Manufacturing with such limited space can be problematic and introduce large amounts of fiber defects, including gaps, overlaps, angle deviation, and steering^{[1],[39]}. These manufacturing defects can lead to decreased performance of composite laminates and failure characteristics over time due to increased fatigue^{[5], [40]}. The initial investigations of manufacturability will be conducted using MATLAB®^{[41]}, while the final tool will be developed with Python®^{[42]}.

### 2A. Methodology and Surrogate Modeling Technique

The prediction of tow gaps, overlaps, angle deviations, and steering was performed with CGTech's VERICUT® Composite Programming (VCP) tool, which identified the existence and location of the defects within the individual plies^{[7]}. VCP is initially provided with the general laminate specifications to begin computing the fiber coverage. The laminate specifications indicated the extent of material coverage and primary fiber orientation for each ply. During the fiber coverage computation within each of the designated ply scenarios, the specific course paths were defined which were consistent with the fiber orientation and layup strategy.

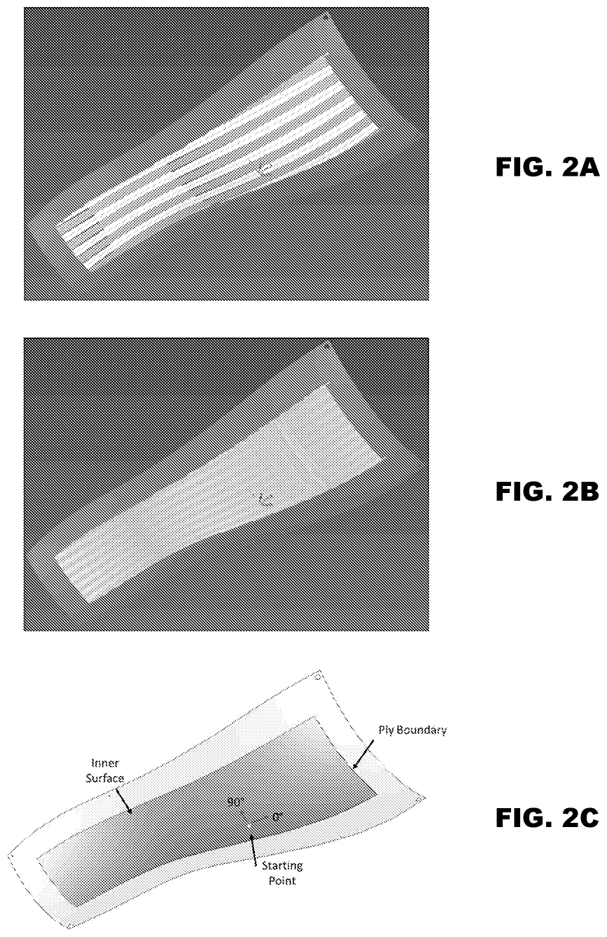

The computed paths can be used to virtually reproduce the fiber placement and resulting geometry of the individual tows. The calculation of defects directly follows the virtual reproduction of tow paths. The geometry of tows was utilized to compute the area of defects; gaps and overlaps (FIGS. 2A and 2B). It is important to note that gaps and overlaps were only computed between neighboring courses and not between individual tows within each course. The placement simulation did not include any draping or deformation of the tows that would occur during actual fiber placement, which would be necessary for the prediction of tow-to-tow interactions within courses. The resulting course to course overlaps were exported from VCP as STEP files defining each gap and overlap instance as a unique closed contour, where fiber angle deviation and steering are defined on a regular grid over the tool surface (FIGS. 2A and 2B).

### 2A.1 Laminate Scenarios

Once the best ply scenarios have been identified, the process planner must combine these to form a full laminate scenario. This is done first by comparing the ply scenarios of the first two plies and choosing the two scenarios with the lowest cumulative stacked gap and overlap area. Then the scenarios from the next ply are compared to the first two chosen ply scenarios. The defects of all three plies are compared through the thickness of the laminate and scored using the metrics described below in 2.4.1 and 2.4.2. The ply scenario from the next ply that contributes to the best overall laminate score is chosen and this process is repeated until a ply scenario has been selected for all plies in the laminate. The creation of the laminate scenario focuses specifically on defect stacking rather than total defect area. This is because it is assumed that total defect area has been optimized in the previous ply optimization step. The final laminate score is a combination of two sub-scores and attempts to describe the overall frequency and severity of defect stacking within your laminate.

### 2A.2 Parametric Discretization of Defects

During the ply optimization process, the course-to-course gap and overlap defects are represented as sets of bounding contours with cartesian coordinates with their locations relative to the 3-dimensional tool surface. In order to detect any interactions between the individual defects in two neighboring plies, even before the actual interaction is computed, each defect must check the nearness of every other defect in the other ply. Therefore, naively for n plies having m defects each, mⁿ comparisons must be performed to even determine which ply defects will interact before the interaction is computed. The problem becomes even more complex with the defects represented in 3-dimensions, where tolerances with the actual representation of the defects complicates the interaction calculation. The number of comparisons may be reduced through such algorithms as spatial hashing, but we propose an alternative method which discretizes defects into a common 2-dimensional domain between each ply, so that the comparisons can be performed in parallel for each element in the discretized domain.

The basis for the defect discretization relies on the parametric domain of the tool surface models. The tool surfaces are represented through non-uniform rational b-splines (NURBS), which is a standard mathematical model for representing curves, surfaces, and solids among many computer-aided design (CAD) softwares. For these representations, NURBS utilizes a net of control points along with its standard piecewise polynomial function to evaluate the entity with varying degrees of geometric continuity. For creating 3-dimensional surfaces, it utilizes a 2-to-3-dimensional mapping, S(u, v)->P_{xyz}. Additionally, the NURBS mapping can be inverted in order to project 3-dimensional entities back to the 2-dimensional parametrized domain of the surface.

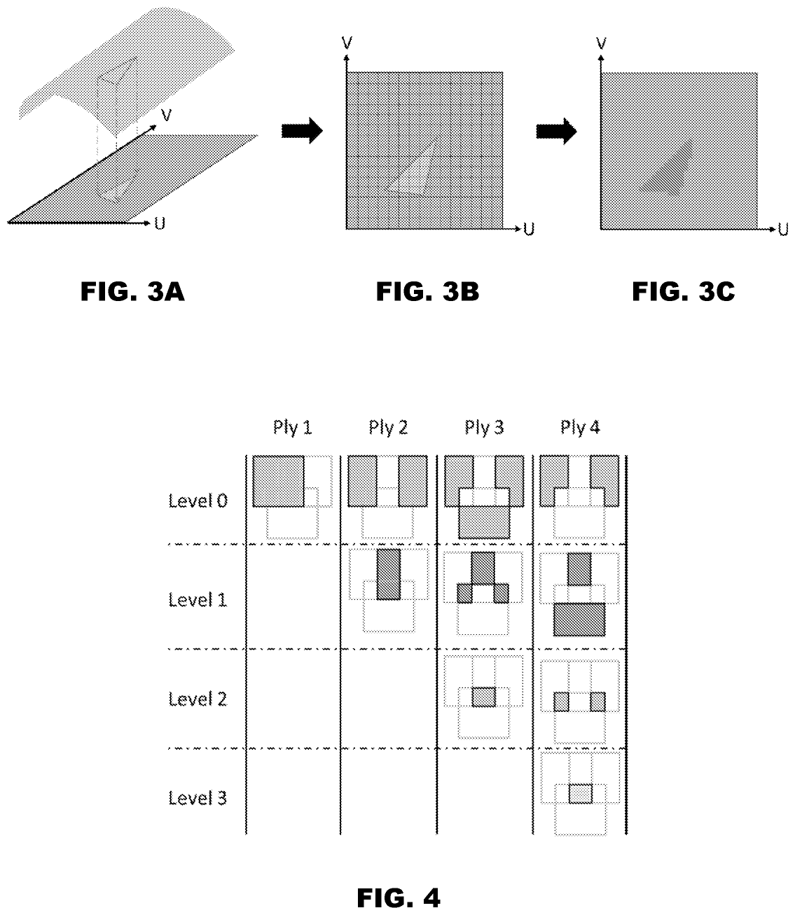

The projection of 3-dimensonal entities relative to a NURBS surface, to its parametric domain serves as the foundation for the defect discretization (FIGS. 3A, 3B, and 3C). The process begins with the cartesian contour representation of the defects, through the use of NURBS curves, creating a closed loop. These are then projected onto the tool surface obtaining their 2-dimensional representations in the tool surface's parametric domain. The parametric domain is then subdivided into a regular rectangular grid for the discretization step. The area enclosed within the projected defect polygon is then mapped to this rectangular grid. The final discretized defects are represented through the on/off cells within the grid. With the newly parametrically discretized defects, the evaluation of stacked defects can be performed efficiently for laminate scenarios of varying size.

### 2A. 3 Identifying Stacked Defects

The stacking of defects is considered throughout the entire thickness of the laminate. Such that defects from the any given ply can interact with any another overlapping defects regardless of the through-thickness distance between plies. The computation of defect interactions begins from the base ply and updates the levels of defect interaction as additional plies are considered. Consider FIG. 4, which describes the evolution of these levels. The shapes denote “defect” regions, where each row defines the level of interaction of those defects, and the grayed boundaries identify the next defect region to consider. Each subsequent column introduces the new defect regions and updates the level of interaction appropriately.

All defects of the initial ply are placed into level 0. When incorporating subsequent plies, the common region of defects are elevated by a single level and checked for updated common regions, where they may again be elevated. The defects will be propagated upward through the interaction levels until no more common regions are detected, at which point another set of defects from the next ply can be incorporated, and the levels updated similarly. The result when all defects from the n plies is a set of at most n-1 levels of defect interaction.

### 2A.4 Measuring Stacked Defects

The measurement and scoring of stacked defects rely principally on the defect levels. These levels describe the area of each defect type at each degree of stacking, starting at level zero which denotes one defect through the thickness with no stacking and continuing until the highest level of stacking. The max number of levels possible for any given laminate is one minus the total number of plies, this means every ply had a defect stacked through the thickness. The scores include a threshold, which corresponds to the level at which the process planner is concerned about defect stacking. Choosing a threshold requires some judgement, if the part requires tight geometrical constraints a lower threshold may be chosen.

### 2A.4.1 Frequency Score

A metric was created, called the frequency score, to describe the total stacked defect area above the chosen threshold in comparison to the total defect area. Starting at the threshold level, defect level area is summed and then divided by the total levels area. The frequency score, Eq. (1), is shown below.

$$Frequency = 1 - \frac{{\sum }_{threshold}^{{n}_{levels}} {A}_{level}}{{\sum }_{0}^{{n}_{levels}} {A}_{level}} \qquad ( 1 )$$

where nₗₑᵥₑₗₛ is the total number of defect levels in the laminate and Aₗₑᵥₑₗ is the area of the level.

The fraction is subtracted from one so that as the defect area stacked beyond the threshold decreases to zero, the frequency score increases to one. A frequency score of zero denotes the case where all defects are stacked to a level beyond the chosen threshold. If the number of defect levels falls below the threshold, a frequency score of 1 is defaulted.

### 2A.4.2 Severity Score

The severity score is similar to the frequency score in that it compares defect levels above the threshold to total defect level area. However, with this metric laminates with more area further above the threshold are scored lower than those with more area closer to the threshold. The severity score, Eq. (2), is shown below.

$$Severity = 1 - \frac{{\sum }_{threshold}^{{n}_{levels}} {( Level - Threshold + 1 )}^{2} * {A}_{level}}{{\sum }_{0}^{{n}_{levels}} ( Level + 1 ) * {A}_{level}} \qquad ( 2 )$$

The main addition here is the squared term in the numerator which attempts to weight the score by how far it is from the threshold. This is balanced similarly in the denominator of the fraction. The purpose of the severity score is to describe the distribution of the stacked defect area beyond the threshold. Two laminate scenarios could have the same frequency score if they have the same amount of stacked area above the threshold regardless of if that area exists in the level immediately above the threshold or in the highest possible level. This metric helps process planners identify laminate scenarios that have particularly high levels of stacking, even if the area is lesser.

### 2B. Surrogate Modeling Technique

Surrogate modeling is a process by which a regression model is utilized to estimate the underlying behavior of a given model. The overall goal of a surrogate model is to build a model that is faster to compute than the original function while also

maintaining sufficient accuracy of known data points^{[16]}. These types of algorithms are useful in scenarios such as an expensive objective function, experimental data, and understanding the inputs and outputs of a design space, all of which are applicable to optimizing the AFP process. The regression model of a surrogate can be queried minimally and are typically quicker to optimize then the functions they are emulating.

Note that if a specific model requires more evaluations to build a sufficient surrogate model than to optimize the original model directly, then surrogate technique will not be beneficial.

The essential steps of surrogate-based optimization (SBO) are shown below.
1. Initial sample selection
2. Construct surrogate model based on training data
3. Search surrogate model for next location of interest
4. Run analysis and update model at the new location(s) found by search
5. Iterate steps 2 to 4 until a convergence criterion is met

The process begins with selection of a group of initial samples by which the surrogate is then built on. The surrogate is searched for the next location of interest and this location is fed into the original function. The location and its results are then added to the surrogate model and the process of finding new locations and updating is repeated until some convergence criteria is met. A brief breakdown of the steps is

provided below, with additional information provided in prior art studies^{[16], [17], [18]}.

### 2B.1 Sampling

Initial sampling can play a large role in the early iterations of the SBO. The initial points should be thoroughly random to understand the behavior of the underlying model. A naïve approach of utilizing strictly uniform or normal distributions to select random points can lead to undesirable clustering. There are various methods for selecting initial evaluation points that counteract this behavior such as grid sampling, Halton sequence^{[19]}, or Latin Hypercube^{[20]}. The latter will be used in the SBO to be implemented in later Sections. Latin hypercube sampling (LHS) generates samples following the Latin square design, or Latin hypercube for higher dimensions, meaning that one sample exists in any given row or column^{[16]}.

### 2B.2 Surrogate Construction

After sampling of the design space, the surrogate model is constructed from the set input data, often referred to as training data. The selection of a specific surrogate model is up to the individual; however, they can be interpolation or regression, and can include known physical and mathematical parameters. For the case of the SBO in the latter, regression models are used without any underlying knowledge of the physics or mathematics involved. This is due in large part to the objective function being a “black box” that has no known behaviors. Note that regression models do not try to exactly match the input data, but they minimize the error between a smooth function and the data points. This type of behavior is considered acceptable since the optimization is trying to find the global trend of model and not necessarily the exact outputs. Therefore, the surrogate model is providing an area of optimal performance not the exact location, but experimentation showed that both typically coincide.

The selection of a regression model results in various types of SBO. One of the most popular options is Gaussian Process Regression (GPR) which results in Bayesian Optimization (BO) techniques. However, other regression models are also available and can be utilized in different ways. The regression models chosen to be evaluated here are Gaussian Process (GP), Support Vector (SV), and Random Forest (RF). Each has a different methodology for optimization and infill used when searching the next location.

### 2B.3 Optimization and Infill

After the construction of a surrogate, optimization can be performed on the surrogate model instead of the original model. Selection of the new data points for further optimization is referred to as infill. The optimization and infill are accomplished through exploitation and exploration tradeoffs. Exploitation is adding an infill point where the model predicts the optimum, while exploration attempts to explore the design space by incorporating uncertainty into the model's predictions. Utilization of the exploration technique requires that the surrogate model provides uncertainty or error measurements. Since the SV and RF regression models do not provide this information, only an exploitation strategy is possible. However, the GP regression model does provide uncertainties so it will use a combination of exploitation and exploration. The techniques for each are described below.

### 2B.3.1 Exploitation

The exploitation strategy used implements a randomized search for the optimum of the surrogate model. A group of n initial points are generated using the LHS technique described above. The values of each of the n points are then found by substituting into the prediction function of the surrogate model. The inputs are then sorted from best to worst predicted value, and the input of the corresponding best value are used as the optimum value for infill. The goal of this random approach is to achieve some small level of exploration by evaluating a relatively small number of possible locations therefore increasing the probability of not being trapped by a single optimum location.

### 2B.3.2 Exploitation and Exploration

When uncertainty values are available, the possibility of exploring the design space while also exploiting arises. There are many techniques available for such infill strategies; however, the expected improvement (EI) technique will be used. EI samples where we have the maximum probability of finding a better point through Eq. (3)^{[16]}.

$$EI ( x ) = ( {f}^{*} - {μ}_{f} ( x ) - ε ) Φ ( \frac{{f}^{*} - {μ}_{f} ( x ) - ε}{{σ}_{f} ( x )} ) + {σ}_{f} ( x ) ϕ ( \frac{{f}^{*} - {μ}_{f} ( x ) - ε}{{σ}_{f} ( x )} ) \qquad ( 3 )$$

Here, Φ and ϕ are the cumulative distribution function (CDF) and probability distribution function (PDF), respectively, for the standard normal distribution. The variables μ_{f} and σ_{f} are the mean and standard deviation functions, f* is the max value encountered so far, and ϵ is a small value to strike a balance between exploration and exploitation (ϵ chosen to be 0.01). Increasing ϵ results in probing locations with a larger σ_{f} as their probability density is more spread. The EI technique will be used; however, other techniques such as probability of improvement, upper confidence bound, and lower confidence bound are also commonly used.

### 2B.4 Surrogate Model Assessment

To evaluate the performance of the SBO and the various regression models, two functions are defined (Eqs. 4 and 5). Equation 4 is based on the sphere function and Equation 5 is based on the Griewank function. These functions are defined based on the methods outlined in prior art^{[21], [22]}. At the beginning of each optimization, a random value f opt is chosen from a uniform distribution in the range (0, 100]. Each function is chosen to have a 2-dimensional input space with an optimum location (xₒₚₜ) chosen randomly from a uniform distribution in the range (−5, 5), also at the beginning of each optimization run. The z variable is then defined by z=x−xₒₚₜ.

$$\begin{matrix}{f}_{1} ( z ) = {f}_{opt} + {\sum }_{i = 1}^{n} {z}_{i}^{2} & ( 4 ) \\ {f}_{2} ( z ) = 1 + \frac{1}{4000} {\sum }_{i = 1}^{n} {z}_{i}^{2} - {\prod }_{i = 1}^{n} cos ( \frac{{z}_{i}}{\sqrt{i}} ) + {f}_{opt} & ( 5 )\end{matrix}$$

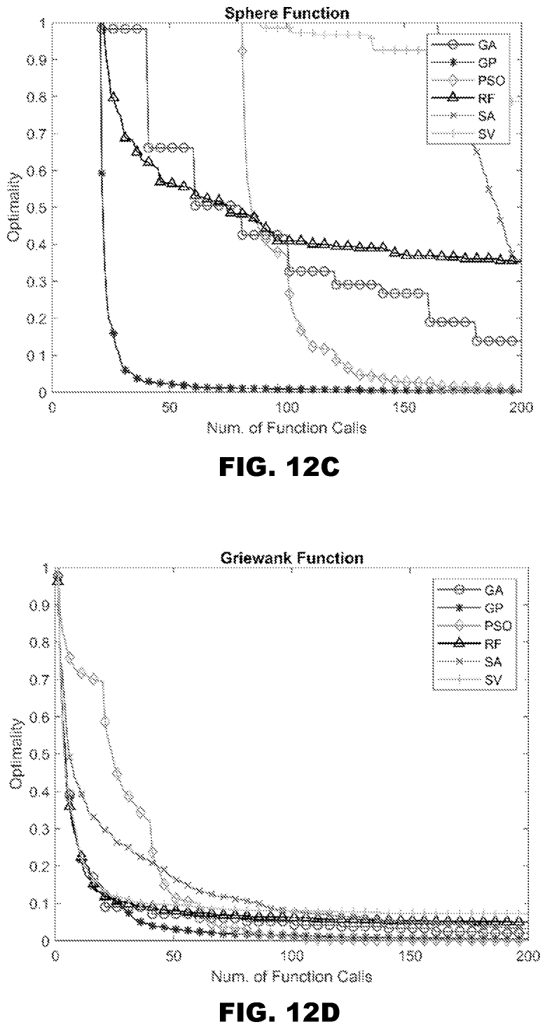

Equations 4 and 5 are plotted in FIG. 12A and FIG. 12B, respectively. Note that the optimum location and its value shown in the figures will differ depending on the values of xₒₚₜ and fₒₚₜ. Both functions are optimized with the surrogate methods described above (GP, SV, RF) as well as 3 other gradient free methods (genetic algorithm (GA), particle swarm optimization (PSO), and simulated annealing (SA)). The comparison of each optimization method's optimality, or difference between current and actual best solution, are plotted in FIG. 12C and FIG. 12D. These results are the average values at each function call across 100 individual optimization runs. Directly from observation, the GP surrogate model outperforms the others in achieving a near absolute optimum in the least number of function calls. This leads to the conclusion that this algorithm will be the most “rapid” when trying to efficiently find the optimum of a given objective function. Therefore, the GP surrogate model is chosen to be used in the application of surrogate models to the optimization of starting points.

### 2C. Methodology for Automated Fiber Placement Defect Predictions

A sufficiently complex tool surface (FIG. 2) with a region of double curvature was selected to ensure the generation of defects for further analysis. Path planning was performed to generate a manufacturing program which consisted of 8-tow courses of 6.35 mm pre-impregnated thermoset composite material. From the path planning, predictions were made for the existence and location of the primary defects, gaps, and overlaps. The fiber paths were then post-processed to include the necessary processing parameters to transition to manufacturing. The automated inspection was performed upon the completion of each ply, before continuing manufacturing.

These steps are not novel on their own; however, they have been combined into a rapid toolchain that is contained within a single environment. This allows for data gathering throughout the AFP process (design, process planning, manufacturing, inspection). Each step comes with its own information which is then combined into a dataset that is usable across multiple process domains. This data accumulation methodology has resulted in the ability to directly compare predicted and as-manufactured defects.

### 2C.1 Pre-Manufacturing Defect Prediction

The prediction of tow gaps, overlaps, angle deviations, and steering was performed with CGTech's VERICUT® Composite Programming (VCP) tool, which

indicated the existence and location of the defects within the individual plies^{[12]}. VCP is initially provided with the general laminate specifications to begin computing the fiber coverage. The laminate specifications indicated the extent of material coverage and primary fiber orientation for each ply. During the fiber coverage computation within each of the designated plies, the specific course paths were defined which were consistent with the fiber orientation and layup strategy. Layup strategies are key to planning fiber placement for complex surfaces, as they control individual fiber paths according to specific relationships between the surface geometry and previous fiber paths. A variety of layup strategies exist for different use cases, such as ensuring consistent fiber angle (rosette), managing fiber curvature (natural), or ensuring consistent alignment between neighboring courses (parallel)^{[13]}. The course paths were the primary result of process planning, which are used along with machine processing parameters to create the final manufacturing program. However, the computed paths can be used to virtually reproduce the fiber placement and resulting geometry of the individual tows.

The calculation of defects directly follows the virtual reproduction of tow paths. The geometry of tows was utilized to compute the area of defects; gaps and overlaps (FIG. 23). It is important to note that gaps and overlaps were only computed between neighboring courses and not between tows within each course. The placement simulation did not include any draping or deformation of the tows that would occur during actual fiber placement, which would be necessary for the prediction of tow-to-tow interactions within courses. The resulting course to course overlaps were exported from VCP as a STEP files defining each gap and overlap instance as a unique closed surface.

### 2C.2 Automated Defect Identification and Classification

Inspection of the AFP manufactured structure was accomplished through the interfacing of custom defect identification tools with the IMT developed Advanced Composite Structures Inspection System (ACSIS)^{[30]}. ACSIS is a ply-by-ply inspection system consisting of a Kuka KR120 robotic arm actuating 4 laser profilometers. ACSIS can create rapid height profiles of a scan surface and compressing height data to create a greyscale image that can be further processed by automated detection software. After layup, the mandrel rotates the ply so that it is exposed to the ACSIS scanners. ACSIS then scans the part and processes the data as the mandrel rotates back into position for the deposition of a new ply.

ACSIS is provided with a complete software suite of defect identification tools, with the current automated detection tools for ACSIS providing patches of image that are classified as a defect or no defect. To provide more accurate defect representations, allowing for exact size and shape data to be extracted from layup scans, a custom data analysis tool was developed to aid in the inspection process. This computer vision tool is constructed from a convolutional neural network performing a semantic image segmentation task. The predicted defect pixels are then extracted and enveloped by a bounding polygon generated by the marching squares algorithm. This polygon and its respective vertices become the basis for defect representation throughout the rest of the inspection process. This tool was built on previous defect detection software that has the capability to automatically label individual pixels in an image as a given defect class, allowing for significantly more refined representation.

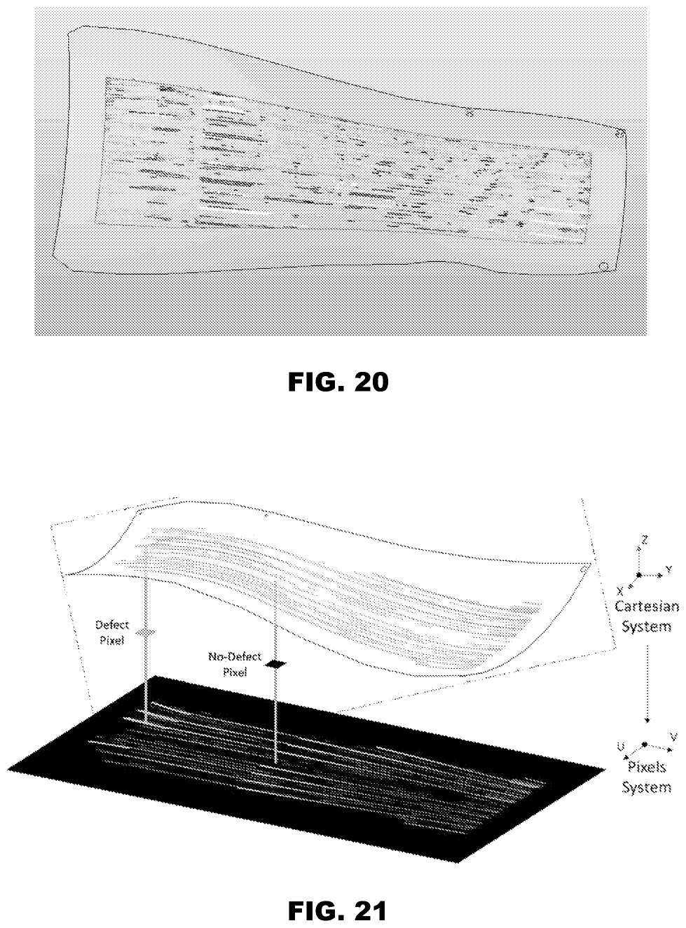

In addition to a more refined defect representation, the inspection software also has the capability to intake ACSIS toolpath data and reconstruct the trajectory of the scanners during inspection. Incorporating this data with the defect representations and tool geometry allow for mapping of the defects in scan images back to their original locations on the tool. It can be seen that the resulted mapping reconstructs an almost exact match to the size, shape, and location of the original defect within the tool coordinate system (FIG. 20).

This detection and classification method has the ability to separate defects into 16 categories. Table 7 below list each of these types with an associated ID and red, green, blue (RGB) color. These IDs and colors combined with the defect shapes are used to communicate the as-manufactured defect data for visualization and comparisons.

### 2C.3 Projecting Results of Analysis

Both the defect predictions and inspection results are returned as boundaries and faces along the tool surface. In this format, comparison is highly difficult to accomplish programmatically due to the small size or high aspect ratio of some of the defects. This is remedied through a coordinate transformation from cartesian space to parametric u/v space (pixels system) as shown in FIG. 21. This transformation is done with the following steps:
1. An empty high-resolution array of pixels is created with the array's size being dependent on the maximum u and v parameters of the tool surface.
2. The boundary of individual defects are projected onto the surface to be represented in u/v space.
3. The projected boundaries are discretized into high fidelity polygons and filled with its associated color (Table 7) to produce the defect area in the pixel array.
4. Step 2 is repeated for each defect present in the current ply.
5. The final array of color pixels is then saved as a PNG file for later use.
6. Steps 1-5 are repeated for each defect type for predicted and as-manufactured defects.

The representation of the defects through the pixel system facilitates faster and more accurate computation of Boolean operations between different defect sources and surface areas resulting from those operations.

### 2D. Algorithms and Design Tool for Strut Design

Design and optimization are highly effective in minimizing the defects in AFP layup especially on complex geometries^{[43], [44], [45]}; therefore, significant work was done in this area. Two transition zones are considered for analysis, linear and radial. The transition zone is created with the variables presented in FIG. 29. Note that the linear transition is obtained with zero values for R₁ and R₂. When developing the algorithm, several aspects of composite manufacturing had to be considered. Seven standard manufacturing angles were considered from zero degrees to ninety degrees (0°, 15°, 30°, 45°, 60°, 75°, 90°). For defect optimization, four types of defects were considered: 1) angle deviation, 2) gaps, 3) overlaps, and 4) steering.

### 2D.1 Transition Zone Algorithm

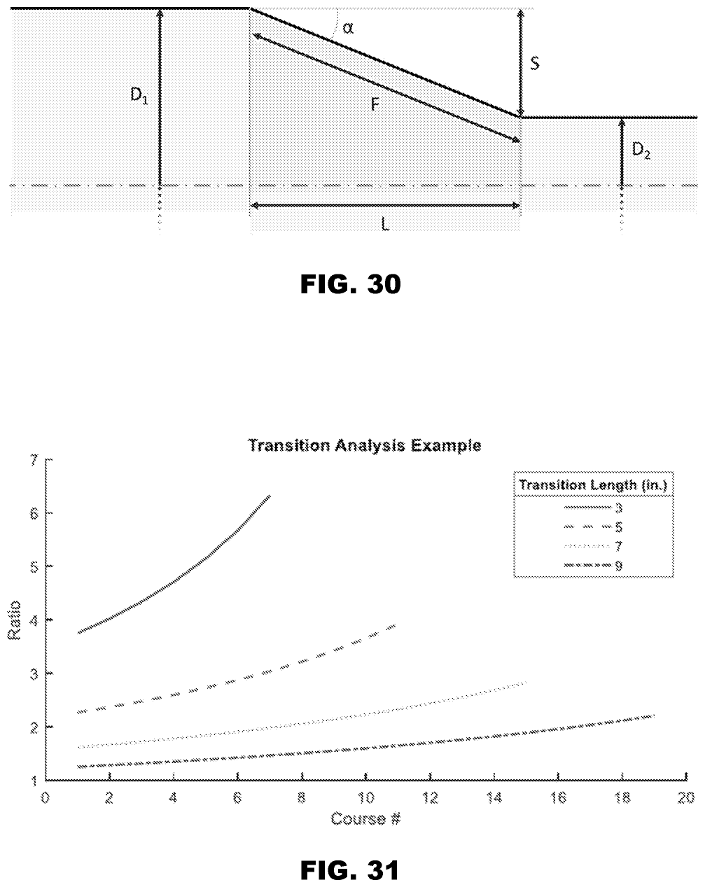

The initial analysis consists of investigating the transition zone of the strut, highlighted below in FIG. 30. It is known that this zone will cause the most issues during manufacturing; therefore, optimizing the geometry in this location is a beneficial starting point. Each of the variables used in the derivation of the algorithm are also labeled in FIG. 30. Here, D₁ and D₂ represent the larger and smaller diameters respectively; L is the total length of the transition zone; S is the 2D change in the two diameters; F is the length of the sloped portion of the transition zone; and α is the angle of the slope. The derivation of the algorithm to be used is presented below.

The first item to consider when analyzing the transition zone is the difference between the two diameters that are being connected (S). This difference is found through Eq. 11. In this Equation, the difference in the diameters is divided by 2 to arrive at the difference for only one side of a 2D projection of the struts surface.

$$S = \frac{{D}_{1} - {D}_{2}}{2} \qquad ( 11 )$$

The next critical aspect of the geometry is the slope of the transition zone as this will determine how quickly the diameters will change. The angle (α) is calculated from Equation 12 below. This equation considers S found above along with the total transition length (L).

$$α = {tan}^{- 1} ( \frac{S}{L} ) \qquad ( 12 )$$

With a calculated, the total diameter loss around strut per course (dT) can be found with Eq. 13. This value provides the change in diameter at the end of the last tow in each course. The dT value will be used in the final ratio calculation to determine manufacturability of the transition zone in question.

dT=2π*t*w*sin (α) (13)

Next, using the transition angle and the known transition length, the length of the sloped portion of the transition zone, termed fiber slope (F), can be found with Equation 14.

$$F = \frac{L}{cos α} \qquad ( 14 )$$

The fiber slope, number of tows per courses (t), and the width of each tow (w) are now used to determine the number of courses (n) that are needed to cover the transition area with Equation 15. Note that then value to be used is the maximum number of courses that can fit within the transition zone, and this happens when the fiber angle is 90° assuming 0° is along the length of the strut. For the case of this algorithm, this will be the worst-case scenario since the maximum number of tows will be within the transition zone. Also note that it is not assumed that the 90° ply will be the most difficult one, it only provides the most tows within the transition zone.

$$n = \frac{F}{t * w} \qquad ( 15 )$$

To obtain the actual number of courses needed (r), the n value is rounded up to the next whole number. The diameter loss of the current course (DLᵢ) is then calculated with Equation 16. In this equation, nᵢ represents the current course number with the first course beginning at the largest diameter and progressing towards the smallest.

DLᵢ=(nᵢ/r)*(D₁−D₂) (16)

Utilizing the local diameter loss, the standardized diameter loss per course (SDLᵢ) with respect to the initial diameter can be obtained with Equation 17. This value provides the current diameter with respect to the diameter that has been lost at the current course.

SDLᵢ=D₁−DLᵢ (17)

Finally, the ratio for each course (Ratioᵢ) is found by dividing dT by the new perimeter and multiplying by 100 (Eq. 18). A lower ratio value represents a better result for the current course. It should be noted that this algorithm does not include effects of radii at the beginning and end of the transition zone. However, due to the small radii used in experimentation, this method can still be used to approximate the effect of the transition zone length and the number of tows.

$${Ratio}_{i} = \frac{dT}{2 π * {SDL}_{i}} * 100 \qquad ( 18 )$$

To further understand what this output represents, the following graphs present example results with given diameters and transition length values. FIG. 31 displays the effect of modifying the transition length of the strut. It becomes obvious that as the transition length decreases, the ratios increase drastically. However, there is a point where further increase of the transition length leads to diminishing returns.

From the Equations presented above, it is clear that the ratio is highly dependent on the transition, and the transition zone is a function of S and L. To analyze each transition length, the integral of each curve from FIG. 31 is computed. This integral is approximated by summing the ratio values at each course and is then divided by the total number of courses (r), as presented in Equation 19.

Σᵢ₌₁^{r}Ratioᵢ/r (19)

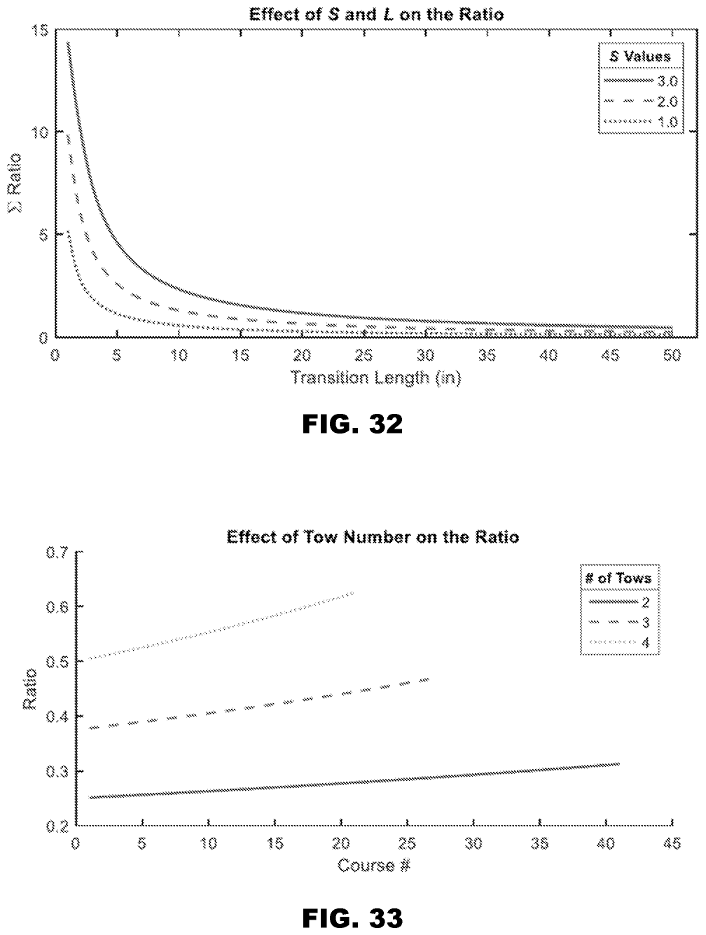

Performing this calculation at various S and L values results in the plot shown in FIG. 32. As previously stated, the ratio values initially change drastically with the transition length. This plot also shows that as the S value decreases, the ratios also decrease. A lower S value would mean that the two diameters are closer each other. This value is usually set based on the structural requirements; therefore, more emphasis should be given to the transition length.

Lastly, the number of tows per course will also affect the ratios due to its role in Eq. 16. FIG. 33 presents this effect graphically with the number of tows varying for 2 to 4 per course. It is immediately seen that decreasing the number of tows per course improves each of the ratio values. This factor can be utilized to determine what the optimal course width is when combined with the defect output.

The presented algorithm provides an initial assessment of the transition zone along with trends related to changing the various variables relating to the transition zone. This method presents limitation when AFP defects are considered as it does not factor in any defects with the courses. With AFP defects being a large part of the structural and manufacturing performance, they must be considered. To tackle this limitation, the Computer-Aided Process Planning (CAPP) software is used to evaluate defect occurrence and severity. The software functionalities are described below.

### 2D.2 CAPP Algorithm

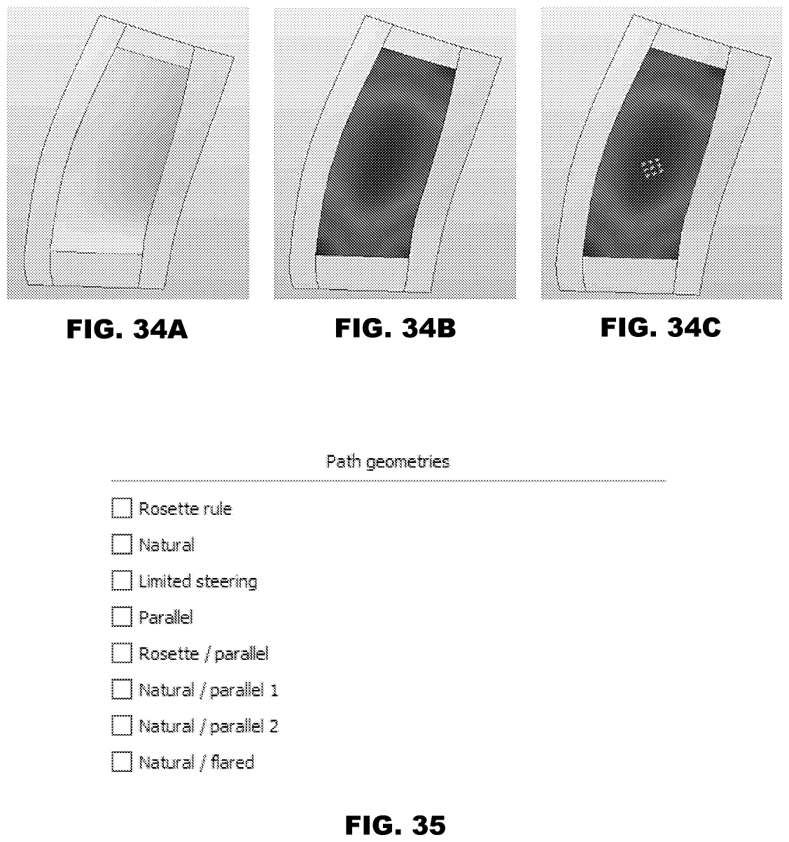

The CAPP^{[2]} process leverages the well-developed VERICUT® Composites Programming (VCP)^{[12]} functionalities. The process begins with splitting the tool surface at each ply boundary to isolate the surface inside (FIG. 34A). The inner surface is then meshed with a user specified density. Using the mesh surface, a heat kernel signature (HKS) analysis is performed (FIG. 34B). This calculation basically heats up the part and sees from where the heat is last to dissipate. Each of these processes are classified as surface preparation for subsequent processing.

Next, the user can select an option to build the starting point arrays. Before building scenarios, the user can select which layup strategies to use from those available in VCP (FIG. 35). A scenario will be built for each strategy selected.

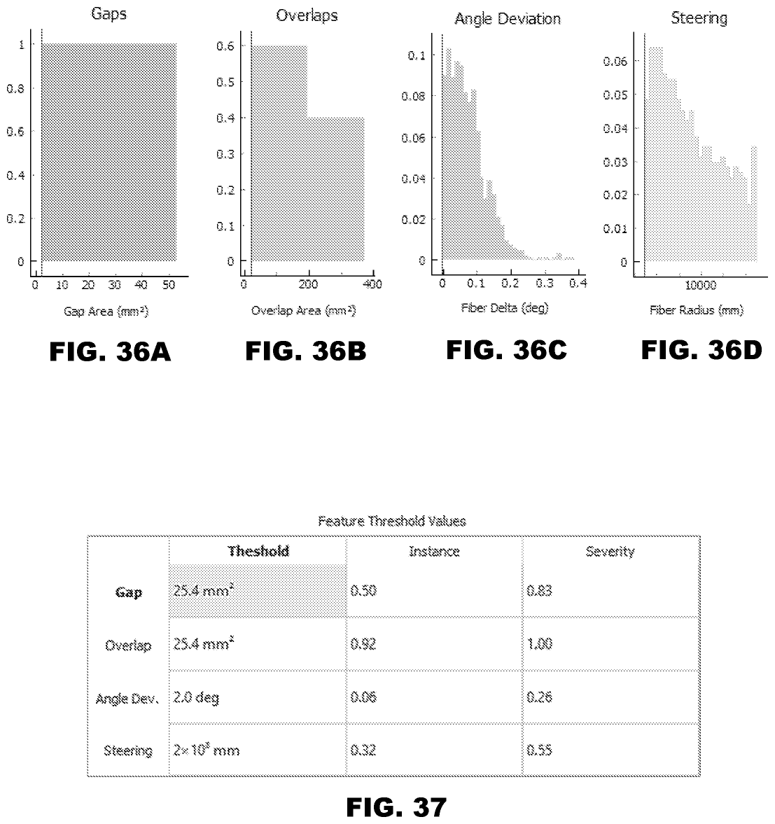

The user can either build a single starting point for each strategy at the max HKS value or can build a 3×3 matrix for each with the center point at the max HKS value (FIG. 34C). Building a single scenario is used for rapid analysis of manufacturability, whereas the matrix of points is utilized for optimization of the starting point. The last option is to build another 3×3 array of points centered on the best scenario extracted through the scoring process. This iteration process can be done until a point is converged on, or until the user is satisfied the manufacturability score. The generated scenarios can then be exported to a template that can be imported directly into VCP. With the imported data, VCP generates the courses and provides an anticipated defect analysis. This analysis contains data associated with gap, overlap, angle deviation, and steering defects. The data generated by VCP is then imported back into the CAPP environment and is visually available through the CAD viewer and through histograms (FIG. 36).

In order to analyze the imported defect data, the user must first input some values. The first values to input are threshold values for gap area, overlap area, angle deviation allowance, and steering radius allowance. The input values can then be used to compute instances and severity of each defect using the Eqs. 20 and 21 below.

$$\begin{matrix}Instance = \# Unacceptable / \# Total & ( 20 ) \\ Severity = \begin{matrix}Accumulated defect \\ above threshold\end{matrix} / Total sum of defects & ( 21 )\end{matrix}$$

The results are then tabulated and presented within the software as shown in FIG. 37. An instance and severity value of 1 corresponds to all the defects being above the acceptability limit given by the user.

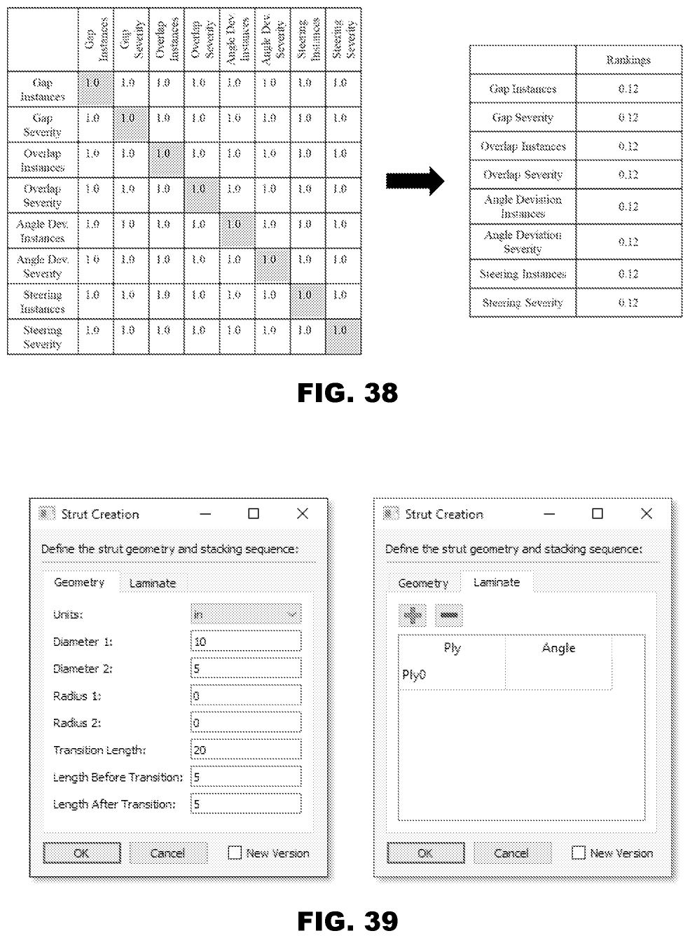

To calculate a single score that combines instance and severity of each defect, an analytic hierarchy process (AHP) matrix is used (FIG. 38). The goal of this matrix is to rank each set of defects based on their importance. The user can change the values within the AHP matrix to put priority on certain defects. This matrix is then converted into rankings that are used to compute the score of each scenario.

The individual scenario scores are computed using Eq. 22. Here, the ranking weights are those computed through the AHP matrix, and the measurement values are from the instance and severity calculations. The scores for all scenarios can be automatically computed with the manufacturability button. This also finds the best score for each ply and stores it for further manufacturability calculations.

Score=Σ Ranking Weight*Measurement Value (22)

The final manufacturability calculation for the entire laminate is computed using Eq. 23. In this Equation, the score is the maximum score from all scenarios in the associated ply. The ply area represents the surface area within the appropriate ply boundary. This Equation allows for the total manufacturability to be a function of the size of each ply. Therefore, a smaller ply affects the score less than a larger one. A manufacturability score of 1 is the best possible value, while 0 is the worst. Through future manufacturing trials, a threshold manufacturability value will be found to define if it is acceptable to continue with manufacturing or if further refinement is necessary.

$$Manufacturability = {\sum }_{n = 1}^{\# plies} {Score}_{n} * Ply {Area}_{n} / {\sum }_{m = 1}^{\# plies} Ply {Area}_{m} \qquad ( 23 )$$

### 2D.3 Design Tool

To provide a rapid iteration capability a design tool was developed to directly build a strut, perform the transition zone analysis, and pass the geometry to the CAPP software. This application was built in Python® and provides the user a dialog with input options to define the shape of the strut and the stacking sequence. FIG. 39a provides an image of the user input options which includes the variables from Table 9 and options for distances before and after the transition. FIG. 39b shows the definition of the stacking sequence where the user can add and remove plies and set the ply angles.

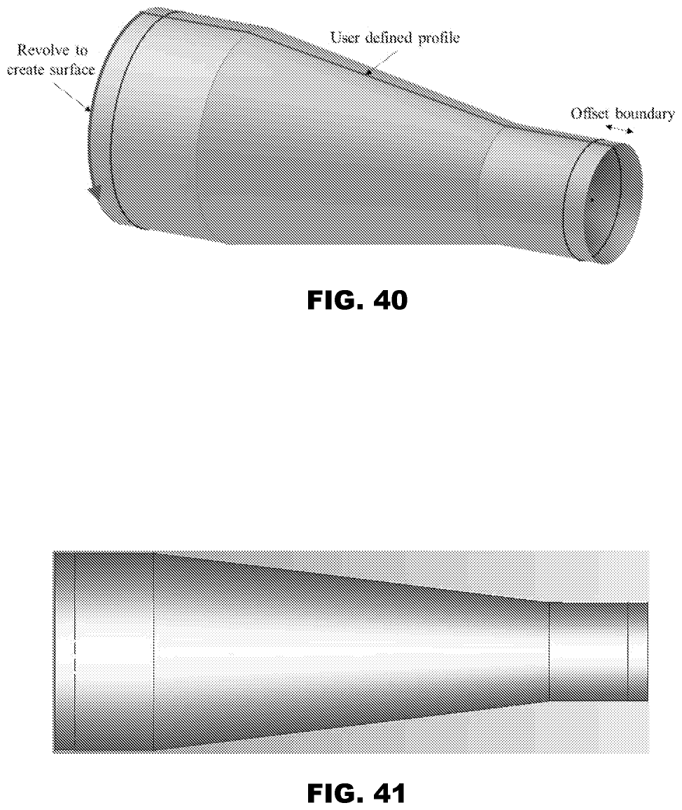

Creation of the actual geometry is performed with a Python ® wrapper of Open Cascade (Python®OCC)^{[46]}. This platform allows a programmatic approach to creating CAD entities utilizing the open-source functionalities of Pythone®CC. Using the design inputs, a strut profile is created that defines the 2D representation of the outer shape. This profile is then revolved around a central axis to create the strut's surface. The two circles that are created from the diameter inputs are then projected and offset by a defined amount to form the ply boundary. For the case of these experiments only a single ply boundary is utilized for every ply angle. The creation of the strut is summarized graphically below in FIG. 40.

An example geometry output is shown below in FIG. 41. This geometry is then analyzed by the transition zone algorithm and passed to the CAPP process. Once analysis is done on this version of the strut, a new one can be created in the same way. All analysis can then be compared directly to determine the best geometry.

### 3A. Virtual Case Study

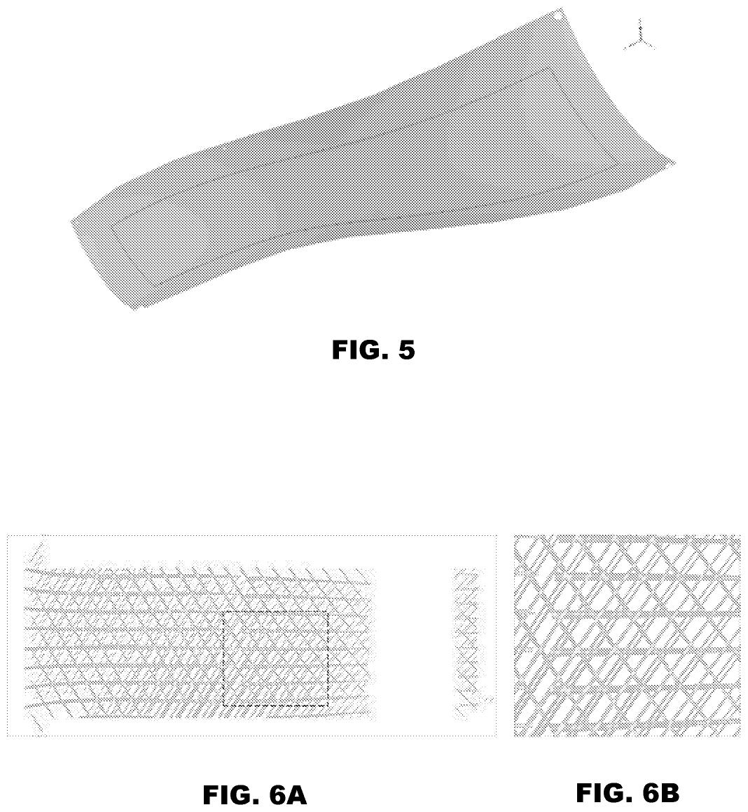

The tool surface selected for the case study provides a non-trivial geometry for the development of fiber defects. The surface (FIG. 5) measures approximately 1.75 m in length and 0.8 m at the widest Section. It features regions with double curvature which forces the generation of many of the geometrically based fiber defects. The depicted ply boundary was used for each ply in the laminate, each ply was assigned a random ply angle from [0°, ±45°, 90°], relative x-axis on the depicted rosette, and the layup strategy was chosen from the selection provided by VCP, including Rosette Rule, Natural, Limited Steering, Parallel, Rosette-Parallel, Natural-Parallel 1 & 2, and Natural Flared. Finally, a random seed point was chosen within the ply boundary set on the tool surface.

Utilizing the random ply scenario generation technique laid out, 20 plies were generated, each with an associated fiber angle. From these fiber angle-ply boundary definitions, 5 ply scenarios were generated for each ply with a random layup strategy and seed point. These processes resulting in a total of 100 ply scenarios which were then processed through VCP to generate the fiber paths and to compute the geometrical fiber defects. The courses were generated according to the ply scenario parameters, with 8 individual ¼″ (6.35 mm) tows. The results of the fiber path generation and ply defect identification were imported to CAPP for further analysis.

With the processed set of plies, multiple laminate scenarios were then generated. Additionally, one set of scenarios only utilized the results from the first 10 plies, whereas the second used all 20 plies for its analysis. The following Sections present the results of the defect level calculations on the tool surface and the resulting frequency and severity scores that occur at varying level scoring thresholds. The results focus solely on the formation of through thickness overlap defects.

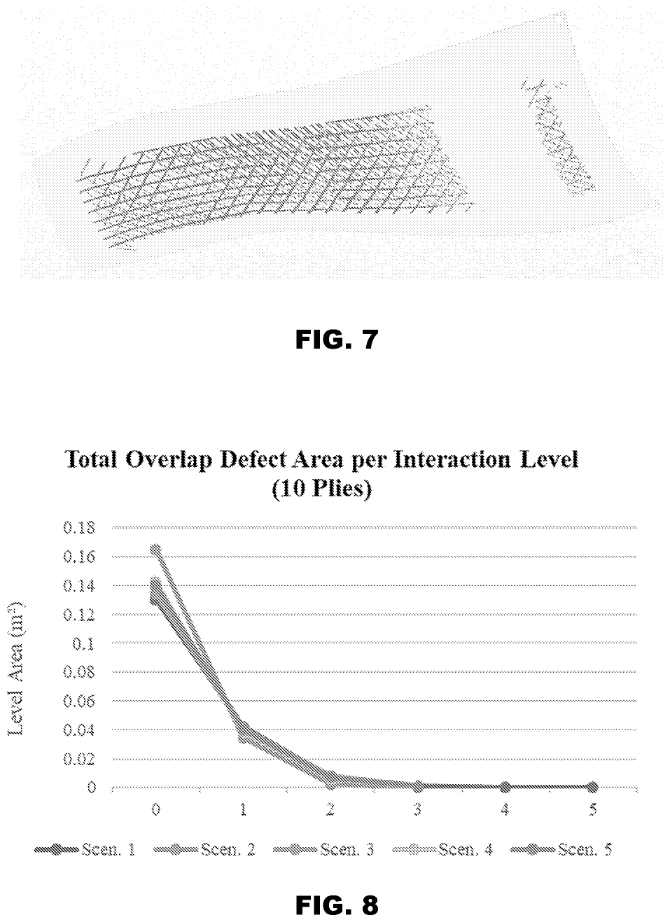

An example of the level scenarios for a 10-ply laminate scenario are presented in FIG. 6A. Additionally, FIG. 6B presents a focused patch from FIG. 6A to highlight the stacking of defects that occur between plies. FIG. 7 presents the application of the discretized levels back to the original tool surface and allows for an undistorted view of the defects which occurred during the mapping to the parametric domain.

### 3A.1 10 Ply Laminate Scenario

The following Section presents the results from the set of 5 laminate scenarios which contained 10 plies each. FIG. 8 presents the level value trends for each of the laminate scenarios groups, beginning from level 0, reach at most level 5, such that a total of 6 defects have been stacked at some regions within the laminate. The resulting scores were obtained utilizing the methods outlined in Section 2.4, where various thresholds including level 1, 2 and 3 were applied. The use of increasing thresholds demonstrates the effect of relaxing defect interaction constraints. The scoring results are presented in Table 2.

TABLE 2
Summary of frequency and severity
scores for 10-ply laminate scenarios

| | Level Threshold | | | | | |
|---|---|---|---|---|---|---|
| | 1 | | 2 | | 3 | |
| | Fre- | | Fre- | | Fre- | Sever- |
| Group | quency | Severity | quency | Severity | quency | ity |
| 1 | 0.72 | 0.66 | 0.95 | 0.95 | 0.99 | 1 |
| 2 | 0.82 | 0.81 | 0.99 | 0.99 | 1 | 1 |
| 3 | 0.73 | 0.68 | 0.95 | 0.96 | 1 | 1 |
| 4 | 0.76 | 0.72 | 0.97 | 0.97 | 1 | 1 |
| 5 | 0.75 | 0.70 | 0.96 | 0.96 | 1 | 1 |
| Average | 0.756 | 0.714 | 0.964 | 0.966 | 0.998 | 1 |

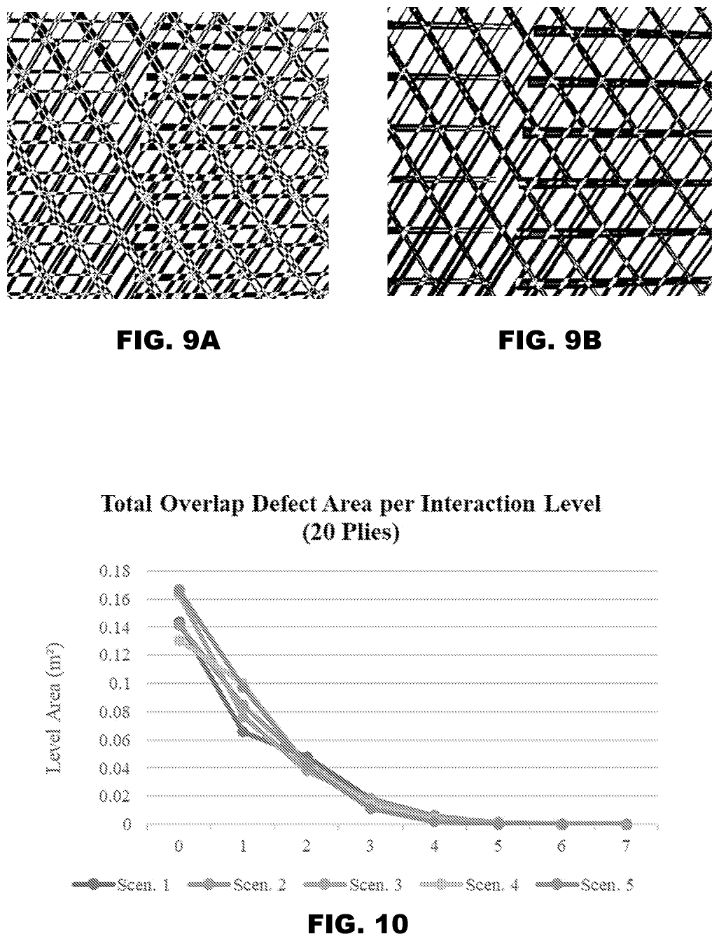

Finally, the results of the scoring methods were used to determine the relative best and worst laminate scenario combinations from the group, depicted in FIG. 9 (including FIGS. 9A and 9B).

### 3A.2 20 Ply Laminate Scenario

The following Section presents the results from the set of 5 laminate scenarios which contained 10 plies each. FIG. 10 presents the level value trends for each of the laminate scenarios groups, beginning from level 0, reach at most level 5, such that a total of 6 defects have been stacked at some regions within the laminate.

The resulting scores were obtained utilizing the methods outlined in Section 2.4, where various thresholds including levels 1-5 were applied. The use of increasing thresholds demonstrates the effect of relaxing defect interaction constraints. The scoring results are presented in Table 3.

TABLE 3
Summary of frequency and severity scores for 20-ply laminate scenarios

| | Level Threshold | | | | | | | | | |
|---|---|---|---|---|---|---|---|---|---|---|
| | 1 | | 2 | | 3 | | 4 | | 5 | |
| Group | Frequency | Severity | Frequency | Severity | Frequency | Severity | Frequency | Severity | Frequency | Severity |
| 1 | 0.51 | −0.06 | 0.74 | 0.61 | 0.91 | 0.89 | 0.97 | 0.97 | 0.99 | 0.99 |
| 2 | 0.49 | 0.07 | 0.78 | 0.69 | 0.93 | 0.92 | 0.98 | 0.98 | 1 | 1 |
| 3 | 0.54 | 0.07 | 0.79 | 0.68 | 0.92 | 0.91 | 0.98 | 0.98 | 1 | 1 |
| 4 | 0.45 | 0.13 | 0.79 | 0.74 | 0.94 | 0.94 | 0.99 | 0.99 | 1 | 1 |
| 5 | 0.52 | 0.27 | 0.83 | 0.81 | 0.96 | 0.96 | 0.99 | 1 | 1 | 1 |
| Average | 0.502 | 0.096 | 0.786 | 0.706 | 0.932 | 0.924 | 0.982 | 0.984 | 0.998 | 0.998 |

### 3B. Application to Starting Point Optimization

The selection of starting point and layup strategies for any given ply is shown to be a time consuming yet highly influential portion of the process planning stage^{[23]}. To semi-automate this task, the SBO methodology outlined above is implemented. The implementation is carried out on a doubly curved tool surface that is known to generate manufacturing defects due to its geometry (FIG. 2C). A series of optimization is performed on ply angles of 0°, 45°, −45°, and 90°. The 0° ply will be optimized for gaps and overlaps, the 45° ply will be optimized for angle deviations, and the −45° and 90° plies will be optimized for a combination of gaps, overlaps, and angle deviation.

### 3B.1 Objective Function Definition

The following Sections will outline the objective function used during optimization. This objective function accounts for defects that result from the selection of layup strategies and starting points. The CAPP software and its scoring methodology are utilized to incorporate the number of defects and their size into a single value in the range^{[0,1]}. The optimum score is 1 and this value represents the manufacturability of a given ply based on defect occurrence. The following details the inputs and calculations involved in the scoring process.

Inputs into the objective function are all within a continuous range of^{[0,1]}Establishing a common range for all inputs assists the surrogate in constructing and updating a more accurate model. This is due to the underlying machine learning processes that are used within the surrogates. Equations 6 and 7 are used to map inputs from the continuous range to the necessary values for performing the objective function. Equation 6 maps to integer space, while Equation 7 maps to real space. Here, v is the continuous variable input and min and max represent the lower and upper bounds of v. Note that initial sample generation within the continuous domain is accomplished with the LHS method described above.

Iₙ=[(Iₘₐₓ−Iₘᵢₙ+1)v]+Iₘᵢₙ (6)

xₙ=(xₘₐₓ−xₘᵢₙ)v+xₘᵢₙ (7)

### 3B.1.1 Starting Point Selection

To decrease the degree of complexity of searching the starting point design space, the 3D ply surface is mapped to a 2D parametric space. This is accomplished through a mesh parameterization using discrete conformal barycentric mapping^{[24],[25]}. This technique is often used in the computer graphics industry to map textures onto a 3D surface. The specific technique to be used here is the minimization of spring energy approach^{[26]}. In short, each edge of the mesh is replaced by a spring. A boundary is chosen (the ply boundary in this case) and projected to a plane with fixed coordinates. The remaining vertices are constrained to the plane and arrange themselves in such a way that the spring energy in the system is minimized. The Equations and solution procedure for this minimization have been excluded as they are outside the scope of this disclosure. The final edge and vertex locations are then used as the parameterization of the mesh. This 2D space can then be used as the search space for the starting point with the limits of the search space being^{[0,1]}in both directions. Barycentric coordinates are used to translate between the 2D, and 3D space.

### 3B.1.2 Defect Analysis

For each starting point and layup strategy selection, a defect analysis in conducted. The defect analysis incorporates 4 main defects extracted from VCP, those being gaps, overlaps, angle deviation and steering. For each defect, there is a threshold value that must be chosen by the process planner. The threshold value represents the minimum threshold value for the defect. This means the final score will disregard defects smaller than this value. Utilizing the defect data, instance, and severity values can be calculated through Equations 8 and 9. The instance value is the number of defect (Def) instances out of the total defects that fall above the threshold value (DefT). Severity then measures the accumulated defect values above the threshold with respect to the total amount of each defect. In short, instances capture the number of defects while severity monitors the impact of the defects.

Instance=#(Def>Def^{T})/#(Def) (8)

Severity=Σ(Def>Def^{T})/Σ(Def) (9)

Table 4 demonstrates a feature threshold table as it would appear within the CAPP software. Note, that the threshold values shown here are also used in the experimentation presented later.

TABLE 4
Feature threshold table

| | Threshold | | Instance | Severity |
|---|---|---|---|---|
| Gap | 300 | mm² | 0.468 | 0.946 |
| Overlap | 300 | mm² | 0.209 | 0.514 |
| Angle Deviation | 2 | deg | 0.369 | 0.860 |
| Steering Radius | 2000 | mm | 0.459 | 0.336 |

The physical measurements of each defect are carried out differently, leading to different methods for calculating the instances and severity. The gap and overlap defects can be defined as area defects, while the angle deviation and steering defects can be defined as point defects. The difference in these defect types, and the methods for finding the respective instances and severities are described below.

### 3B.1.3 Area and Point Defects

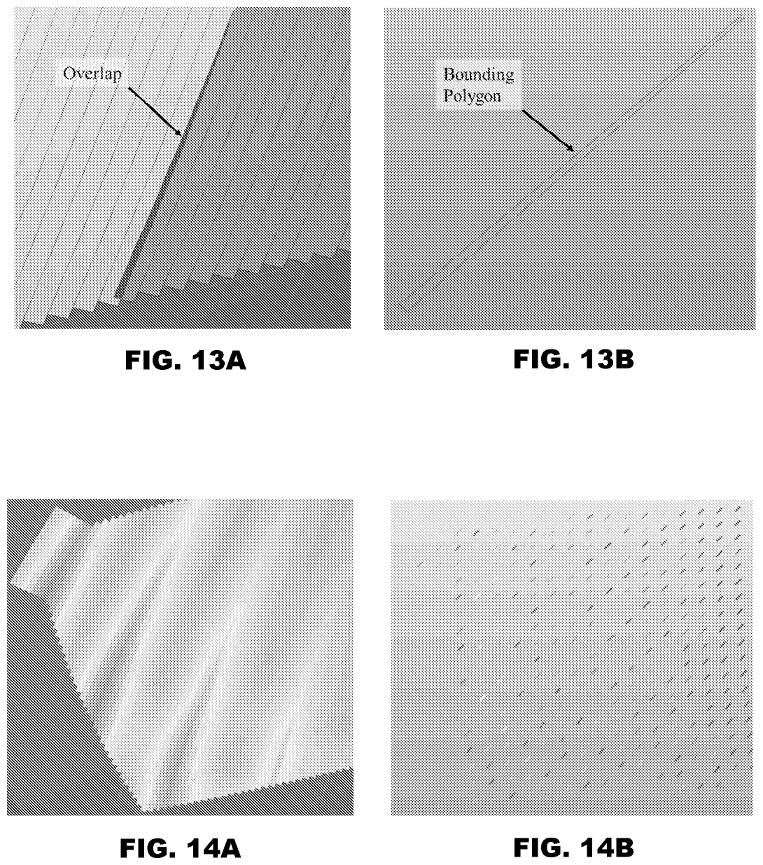

Area defects (gaps and overlaps) are defects that are defined by a bounding polygon. FIGS. 13A and 13B show, respectively, an example overlap defect found in VCP and its bounding polygon extracted through the CAPP software. Each bounding polygon is also accompanied with an area of the polygon. Using the threshold value for gaps and overlaps, the instances is computed by counting the number of polygons that exceed the threshold and dividing by the total polygons. The severity then accumulates all the areas above the threshold and divides them with the total sum of the areas for each defect.

Point defects (angle deviation and steering) are defects that are defined on a point-by-point basis. FIGS. 14A and 14B show, respectively, an example angle deviation analysis where the deviations are shown in a heat-map within VCP, along with the discrete point values extracted through the CAPP software. Each point is identified by a cartesian coordinate and a corresponding defect value at the respective location. Utilizing the thresholds for the defects, the instance is calculated by counting the number of points that exceed the threshold and dividing by the total number of points. The severity then accumulates the defect value at each point exceeding the threshold and divides by the sum of all defect values for each defect.

### 3B.1.4 Comparison and Ranking

The comparison and ranking process provides a method for creating an overall ranking of many features through a series of pair-wise comparisons through the Analytical Hierarchy Process (AHP)^{[27]}. AHP works by allowing an operator to decide how severe each defect is in comparison to other defects. By doing pair-wise comparisons between each defect an overall ranking for how important each defect is can be created. Using the final overall defect rankings and the measured defect instances and severities, a score can be assigned to each ply. An example AHP matrix with all values set to unity is shown below in FIG. 15.

The calculation of the weights of each feature in the AHP matrix begins with summing each column. The values in each column are then divided by the sum of the respective column. The weight is then found by averaging each row. The weights used during experimentation are provided below in Table 5.

TABLE 5
Weights used for experimentation

| | Weights | | |
|---|---|---|---|
| | Gap/Lap | Ang. Dev. | Combined |
| Gap Instances | 0.15 | .03 | 0.15 |
| Gap Severity | 0.26 | .03 | 0.18 |
| Overlap Instances | 0.15 | .03 | 0.15 |
| Overlap Severity | 0.26 | .03 | 0.18 |
| Angle Dev. Instances | 0.04 | .32 | 0.11 |
| Angle Dev. Severity | 0.04 | .49 | 0.13 |
| Steering Instances | 0.04 | .03 | 0.04 |
| Steering Severity | 0.04 | .03 | 0.04 |

Utilizing the weights and measured values, the final score can be calculated with Eq. 10. Here, each of the weights is multiplied by the measured value to obtain a score for the respective feature. One minus the sum of these scores results in the overall score of the ply. A score of 1 is the optimal score and would mean that there are no defects present that exceed the thresholds.

$$Score = 1 - {\sum }_{i = 1}^{n} {Weight}_{i} * Measured {Value}_{i} \qquad ( 10 )$$

### 3B.2 Extension to Layup Strategy Optimization

The scoring methodology outlined above can be applied to evaluate multiple layup strategies while also optimizing the starting point within a given strategy. This requires integer values to be assigned to each layup strategy, and then a mixed integer method is used to map the continuous domain into the integer values are described above (Eq. 6). The layup strategies used and their associated integer IDs are provided below in Table 6. Note, that the provided values are one indexed; however, these values are zero indexed when used in the optimization code.

TABLE 6
Layup strategies and their associated integer IDs

| Integer ID | Layup Strategy |
|---|---|
| 1 | Rosette |
| 2 | Natural |
| 3 | Parallel |
| 4 | Rosette Parallel |
| 5 | Natural Parallel |

### 3C. Case Studies

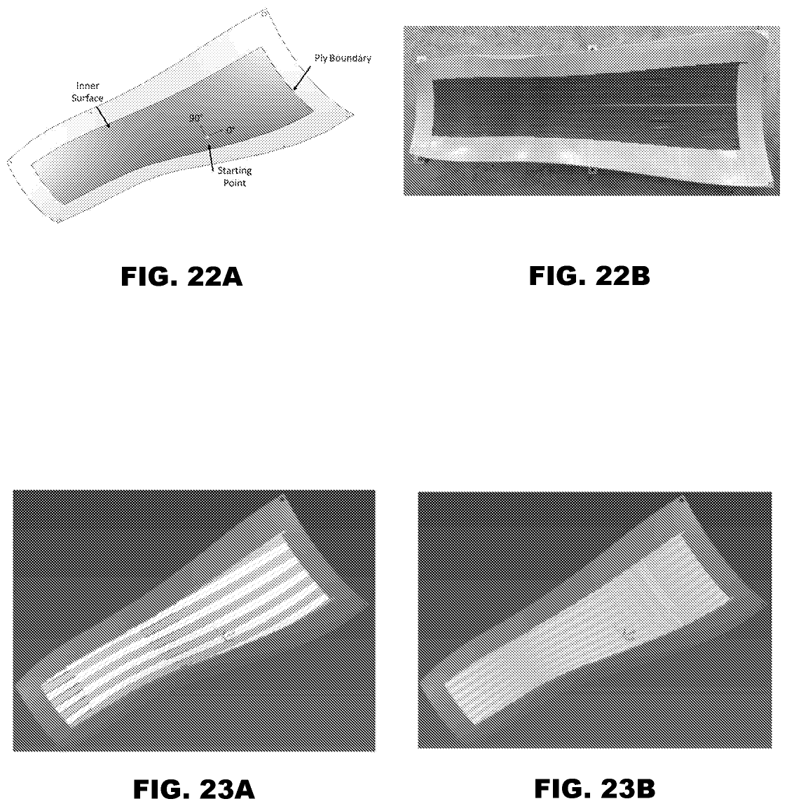

For experimentation, a 0° ply angle was used with the ply boundary and starting point shown in FIG. 22A, combined with a Rosette Rule layup strategy. This information was then used to manufacture the 0° ply FIG. 22B. The following Section details the data collected from both the defect predictions and the inspection results.

### 3C.1 Defect Predictions

The zero-degree ply was processed through VCP to generate the defect predictions. A total of 8 tows were utilized for each course to match the manufacturing capabilities. The maximum course-to-course gap was set to 0 mm and a maximum overlap of 6.35 mm (one tow width). These settings ensured the presence of material overlap while preventing gaps. Those settings enabled the comparison of predictions and inspection for overlaps, while ensuring the present of any gaps would occur as a result of manufacturing processes and would only be detected by the inspection. Following generation of the course paths and individual tow geometry, the defect analysis was performed for gaps, overlaps, and angle deviation.

No tow gaps were detected during the defect analysis. However, tow overlaps and angle deviation were detected extensively through the divergent regions of the tool surface. The overlaps (FIG. 23A) exist between the neighboring courses, alternatingly depicted in white and gray. Fiber angle deviations (FIG. 23B) are depicted on a continuous spectrum, from little-to-no deviation to 3-4° of fiber angle deviation. The defects were then converted to the discretized pixel representation for further investigation (FIG. 21).

### 3C.2 Defect Inspection

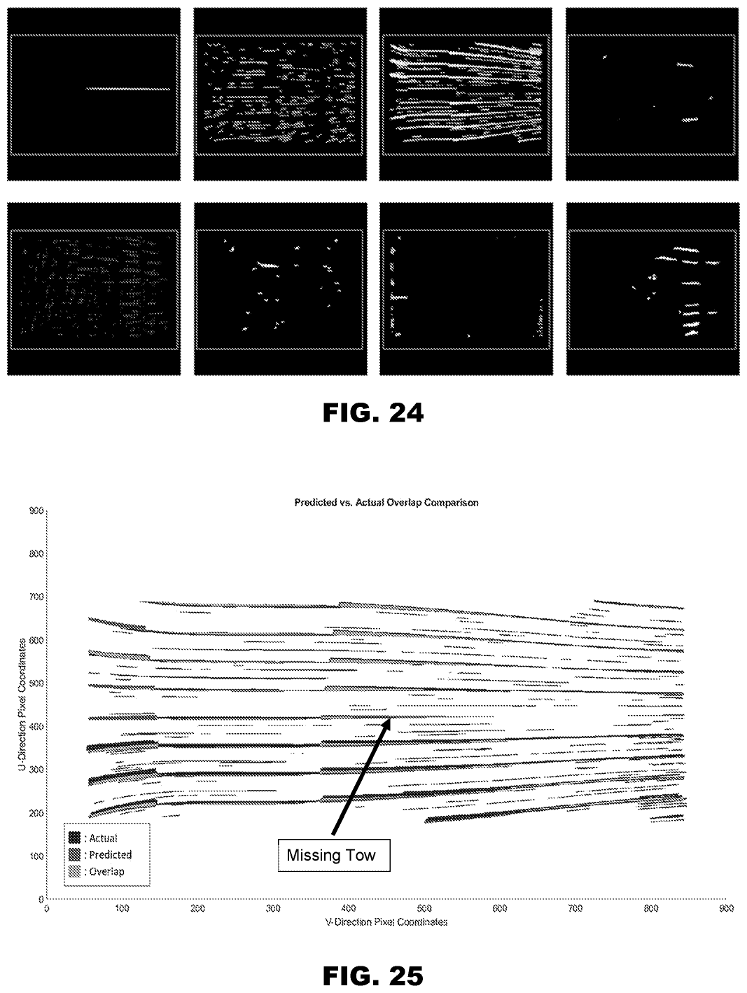

Following the placement of the 0° ply, the ACS IS profilometry inspection was performed. Through the inspection process, a total of 8 defect types were extracted (missing tow, gap, overlap, pucker, wrinkle, surface separation, loose tow, and bridging). The inspection was programmed to replicate the manufacturing motion in order to scan the individual courses. The profilometry data was then stitched together to generate a unified scan of the ply to finally generate the labeled defect data. These defects were referenced back to the tool surface and then pixelated, using the previously defined method, resulting in the images in FIG. 24.

### 3C.3 Comparison of Predicted and Detected Defects

The comparison of the predicted and detected defects were performed using the pixelated data generated through the methods outlined in Section 2.3. The projections mapped the defects back to the individual faces of the CAD model; however, the tool surface utilized only had a single face. The comparison of the predicted and actual overlaps is presented in FIG. 25. The predicted overlaps correspond to the edge of neighboring courses, whereas the actual overlaps were measured over the entire ply and thus detected overlaps between tows within individual courses as well as the overlaps between courses. It is important to note that the prediction of gaps and overlaps were limited to simple geometric models, whereas prediction of tow-tow interactions may require more detailed models to account for tow deformation over the tool surface during placement.

Another possible reason for mismatch between the predicted and measured overlaps is the development of other types of defects in that region during manufacturing and their capture and labeling under another type of defect during inspection. For instance, the occurrence of a missing tow where a gap was predicted to occur can result in such discrepancy. The same applies to out-of-plane defects such as puckers, wrinkles, surface separation, and bridging, where a “designed” overlap could possibly act as an instigator for such defects. As a result of this difference in capabilities between prediction and actual inspection, the actual overlap area was approximately 23% greater than the predicted area (Table 8).

TABLE 8
Comparisons of overlap defect areas
Overlap Defect Area Comparisons

| | | |
|---|---|---|
| Predicted area | 55001.6 | mm² |
| Actual area | 67717.9 | mm² |
| Error | 18.8% | |

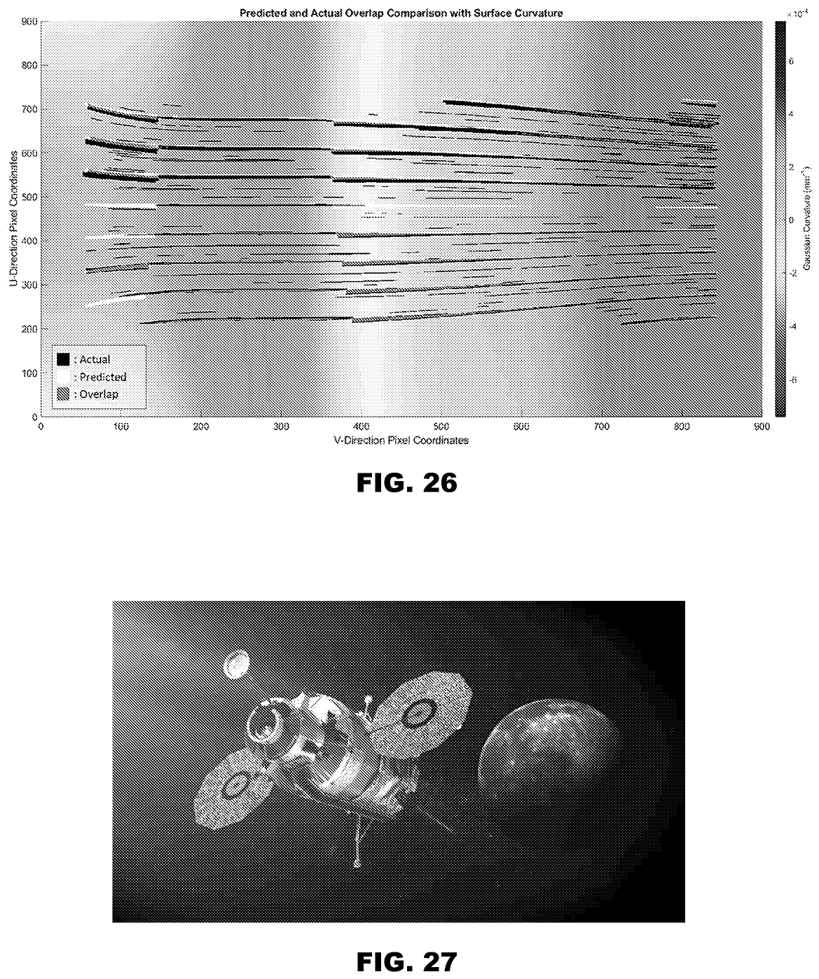

Additionally, the results of the predicted and actual defects were overlayed onto the curvature of the surface (FIG. 26). The extent of the defects closely matches the curvature of the surface, where sets of defects are delineated at the changes of curvature. These results reflect on the modification of tow count and course direction in order to meet the gap and overlap settings that were utilized.

### 3D. Experimentation Plan for Strut Design

### 3D.1 Test Matrix

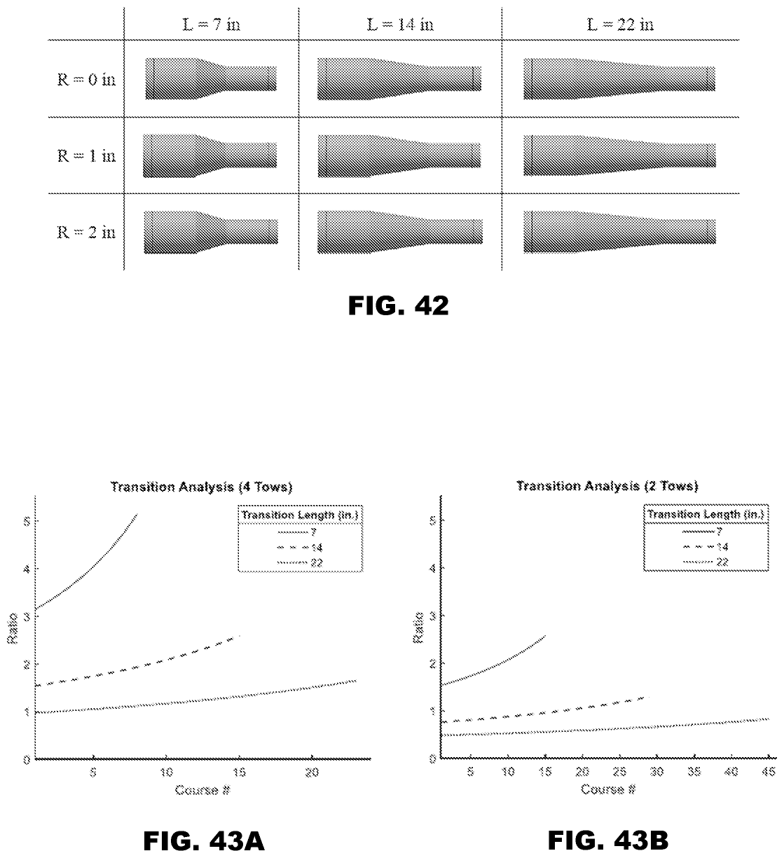

Experimentation consisted of a parametric study of a general strut geometry to investigate its manufacturability based on various design inputs and to choose an optimal shape. The design parameters are set to be the transitions length and the radius at the beginning and end of the transition zone. Three different transition zone lengths (7 in., 14 in., 22 in.) and three radii values (0 in., 1 in., 2 in.) are used resulting in the 9 design variations shown in FIG. 42.

The trial IDs that will be used to differentiate between each trial are presented in Table 10. For each ID, the first number represents the trial number, and the second number represents the number of tows used in the respective trial. This Table also provides each of the design variables used for each trial. All trials utilized tows with a width of 0.25 in. Also note that all trials use the Rosette Rule layup strategy due to unsuccessful course generation with other strategies in VCP.

TABLE 10
Description of each variable for the various trials

| Trial | D1 (in) | D2 (in) | L (in) | R1 (in) | R2 (in) |
|---|---|---|---|---|---|
| 1-4 | 4.75 | 2.75 | 7 | 0 | 0 |
| 2-4 | 4.75 | 2.75 | 14 | 0 | 0 |
| 3-4 | 4.75 | 2.75 | 22 | 0 | 0 |
| 4-4 | 4.75 | 2.75 | 7 | 1 | 1 |
| 5-4 | 4.75 | 2.75 | 14 | 1 | 1 |
| 6-4 | 4.75 | 2.75 | 22 | 1 | 1 |
| 7-4 | 4.75 | 2.75 | 7 | 2 | 2 |
| 8-4 | 4.75 | 2.75 | 14 | 2 | 2 |
| 9-4 | 4.75 | 2.75 | 22 | 2 | 2 |
| 1-2 | 4.75 | 2.75 | 7 | 0 | 0 |
| 2-2 | 4.75 | 2.75 | 14 | 0 | 0 |
| 3-2 | 4.75 | 2.75 | 22 | 0 | 0 |
| 4-2 | 4.75 | 2.75 | 7 | 1 | 1 |
| 5-2 | 4.75 | 2.75 | 14 | 1 | 1 |
| 6-2 | 4.75 | 2.75 | 22 | 1 | 1 |
| 7-2 | 4.75 | 2.75 | 7 | 2 | 2 |
| 8-2 | 4.75 | 2.75 | 14 | 2 | 2 |
| 9-2 | 4.75 | 2.75 | 22 | 2 | 2 |

### 3D.2 CAPP Ranking Strategy

As mentioned in Section 2.2, the manufacturability scoring is highly dependent on user inputs for the threshold of each defect and AHP matrix values. For the presented experiments, the gap and overlap thresholds are set to 25.4 mm², the angle deviation threshold is set at 2°, and the steering threshold is set at 2000 mm. The values chosen are typical values that are of concern for each defect. Below the given values, it is assumed that the defects will have a small effect on the structural performance. The threshold values are summarized below in Table 11.

TABLE 11
Defect threshold values for the experiments

| Defect | Threshold Value | |
|---|---|---|
| Gap | 25.4 | mm² |
| Overlap | 25.4 | mm² |
| Angle Deviation | 2 | deg |
| Steering | 2000 | mm |

For the AHP matrix, all values are chosen to be 1. This will factor in each defect's instance and severity equally, leading to a scoring that incorporates all defects. All defects are to be factored equally to create a broad overview of possible issues with each investigated design. The overall rankings generated from the AHP matrix are provided in Table 12.

TABLE 12
AHP ranking for each defect category

| Item | Ranking |
|---|---|
| Gap Instances | 0.12 |
| Gap Severity | 0.12 |
| Overlap Instances | 0.12 |
| Overlap Severity | 0.12 |
| Angle Deviation Instances | 0.12 |
| Angle Deviation Severity | 0.12 |
| Steering Instances | 0.12 |
| Steering Severity | 0.12 |

### 4A. Discussion

The case study has presented a demonstration of the methodologies set forth. The demonstration focused on the generation of overlap defects and their interactions throughout laminates of varying sizes, namely 10 and 20 plies each. A common ply boundary was held constant for each ply, and a random fiber angle was then assigned. The final set of parameters required for the generation of fiber path generation were randomly assigned to the various ply scenarios. The laminate scenarios utilized for the demonstration were randomly chosen from that set of ply scenarios.

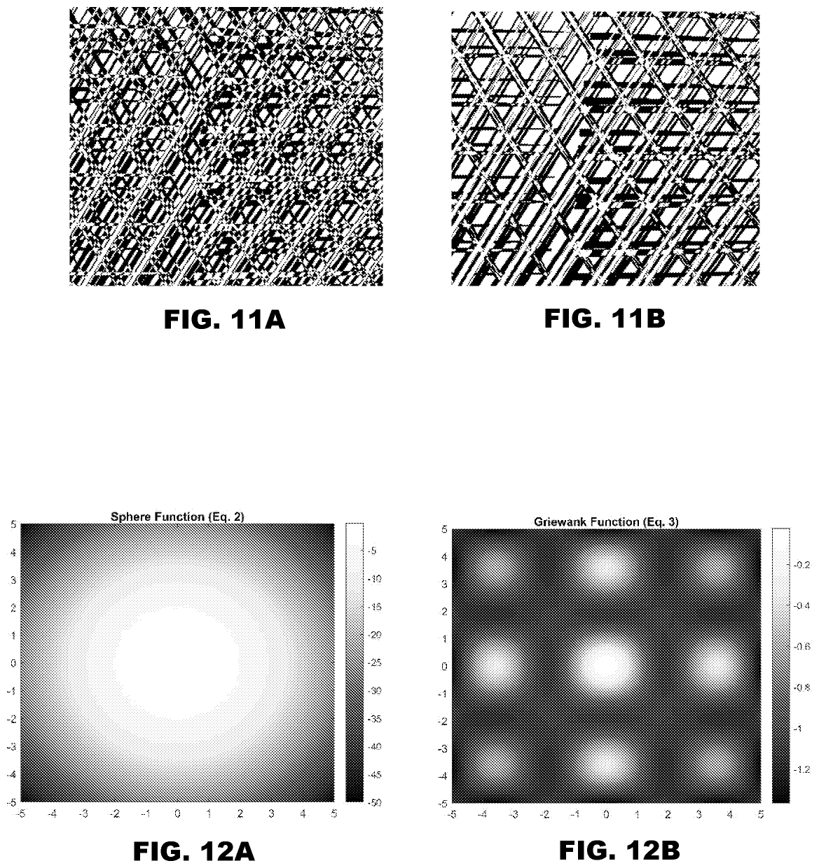

The figures showing the graph of overlap defect level distribution (FIG. 8 and FIG. 10) present an interesting relationship to the final distributions of scores presented through the tables (Tables 1 and 2). The groups which exhibit the best (highest) frequency and severity scores exhibit the highest amount of spatial defect spreading, compared to their lowest average scoring scenario of their respective laminate scenario groups. These groups also exhibited lower overall number of levels, indicating reduced defect interaction overlap defects between the plies throughout the laminate. The spatial defect spreading of FIG. 9 and FIGS. 11A-11B would account for the reduced levels of interaction, as plies with partially shifted defects had been correctly identified by the frequency and severity scores as having reduce interactions. Ideally, more variation might be observed in the overall distributions of defect areas between the different levels; however, such a scenario would likely be realized once the current scoring techniques become implemented into a proper laminate optimization routine within the CAPP software.

### 4B. Results and Discussion

The results from the gap and overlap, angle deviation, and combined optimizations are presented below. For each case, a 3D input vector was first used to establish which layup strategies will be optimal. The convergence criterion for this optimization is associated with a total number of function calls, where 25 initial random points are sampled using LHS and then 25 iterations are performed. The selection of 25 initial points was chosen based on experimentation in which 25 samples showed to be adequate to evaluate initial behavior. Next, the best performing layup strategy was selected, and the input vector was reduced to 2 dimensions. The surrogate model associated with the best strategy was optimized for another 25 iterations. The goal of this is to limit the number of function calls to investigate the feasibility of rapidly finding an adequate solution with SBO. Further iterations can be performed until the optimization converges on a single point.

### 4B.1 Gap and Overlap Optimization

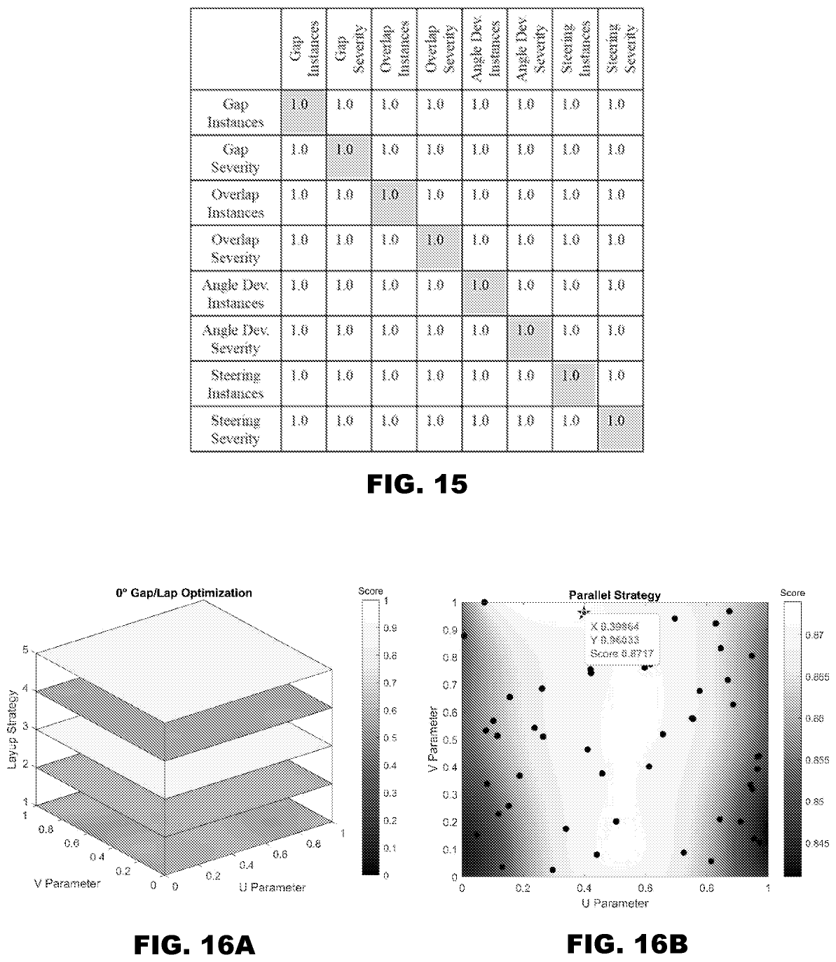

FIGS. 16A-16B, as described below, provide the results of the gap and overlap optimization. From FIG. 16A, it is apparent that the parallel and the natural parallel strategy perform the best. From these two strategies, the maximum score was found within the parallel strategy, as highlighted in FIG. 16B. Since this strategy ensures an equal spacing between any two points on a given set of courses, it inherently limits the appearance of gaps and overlaps. However, angle deviation and steering defects can become an issue. Due to the incorporation of these defects in the weighting from the AHP matrix, the score does not reach the maximum value of 1. Note that in FIG. 16B, the surrogate model (shown as a contour plot) predicts a better score than the point highlighted. However, only the best-known points are selected from to choose the optimum starting point.

### 4B.2 Angle Deviation Optimization

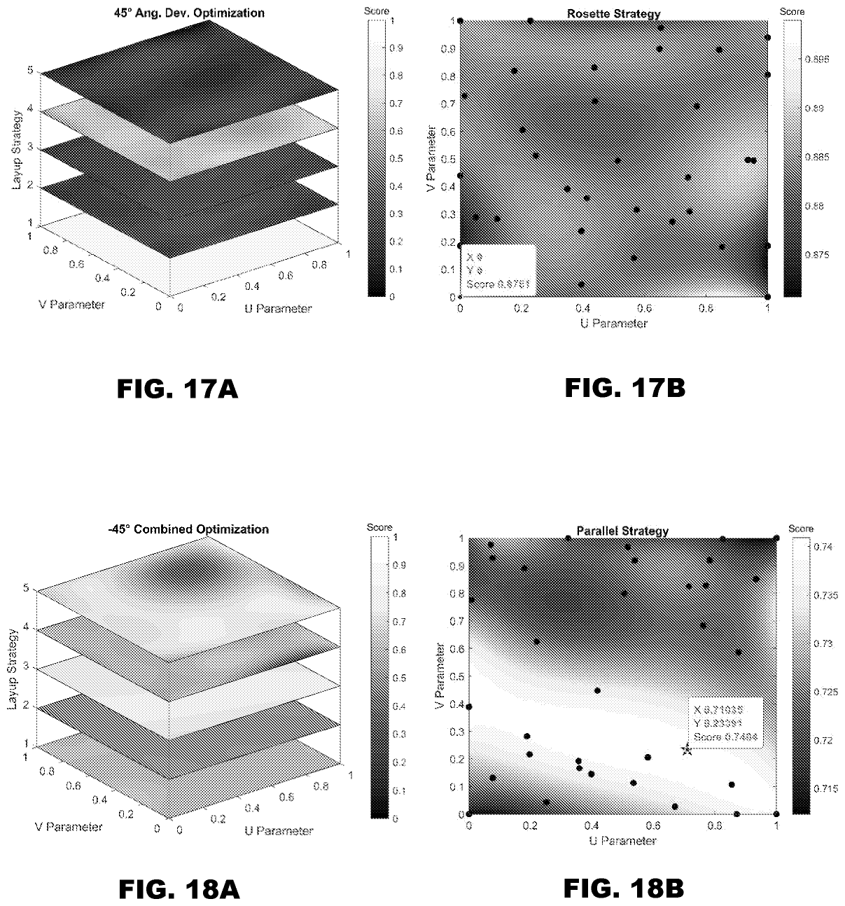

Similar to before, FIGS. 17A-17B display the combined and best-found results from the optimization for angle deviations. As expected, the Rosette Strategy performed the best with the highest scoring starting point highlighted in FIG. 17B. The Rosette Strategy attempts to maintain fiber orientation across the entire ply boundary, regardless of other factors such as gap and overlap occurrence. The AHP weights for this optimization factor in a small amount of a penalty due to this occurrence. This penalty along with possible steering violations lead to the maximum score of 0.878.

### 4B.3 Combined Optimization

In the above, the optimizations were focused on eliminating a single type of defect. However, often a combination of these defects is required to maintain the expected outcome structurally along with certain limitations certification wise. The combined optimization shown in FIGS. 18A-18B attempts to find an optimum layup strategy and starting point that can incorporate multiple defect types while limiting their instances and severity through the thresholds mentioned in Section 3.1.2. This optimization led to a result with the parallel strategy being optimal with the best starting point shown in FIG. 18B. The natural parallel strategy also performed nearly equally, however, had slightly lower scores overall. Note, that no hard limits were incorporated into the optimization, and therefore, the results are allowed to exceed thresholds without severe penalties. Such a situation may not be allowed when considering certification or optimum structural performance.

For the optimization of the 90° ply, no defects were predicted for any of the layup strategies or starting points. Due to no defects being present, an optimal score of 1 is achieved on the first iteration and the optimization is instructed to stop. Therefore, any combination of the two will be sufficient. The lack of defect occurrence is attributed to the constant curvature in the 90° direction of the tool. This leads to little variation from a linear path; hence, any propagation of the initial reference curve will lead to minimal angle deviation and gap/overlap occurrence.

### 4B.4 Discussion

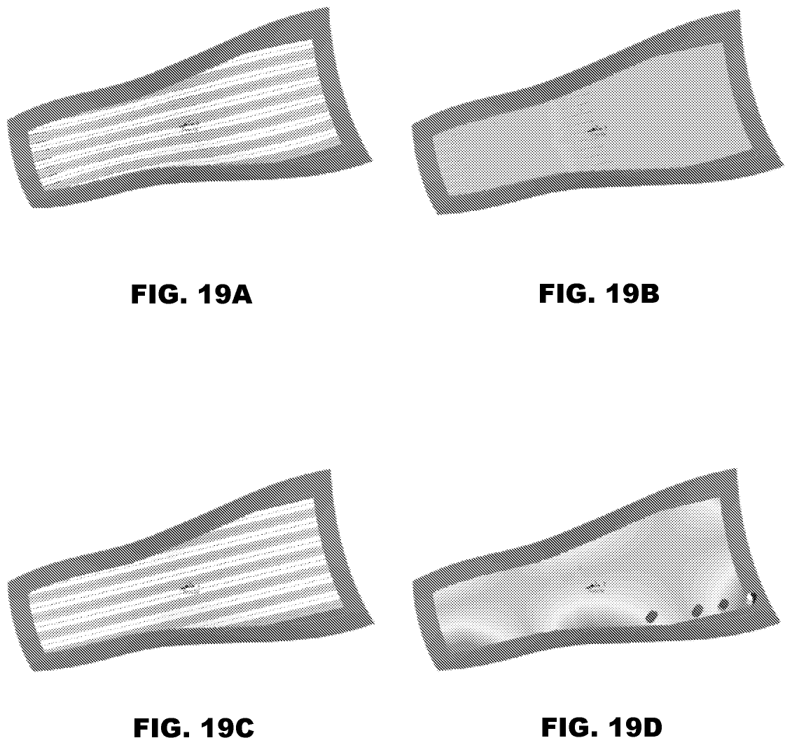

The optimization of layup strategy and starting points selection for AFP manufacturing is a highly complex process. There is often a need for engineering compromise between a structure that is optimal to manufacture and has optimum performance. When trying to select a combination of process planning inputs by hand, the process planner must have a high level of knowledge to optimize for the AFP process but must also communicate with the designer to maintain structural constraints. For example, prior to the gap and overlap optimization, angle deviations instances may have been very limited with selection of a strategy such as Rosette (FIGS. 19A-19B). After optimization, gaps and overlaps have been removed; however, angle deviation instances and severity have increased (FIGS. 19C-19D).

The SBO technique established above can help to automate such selections with constraints from both the designer and process planner as inputs into the AHP matrix. This selection along with the thresholds are critical parameters that influence the outcomes of the optimization. Further, “hard limits” can also be incorporated to ensure if a specific set of inputs exceed the thresholds they will be penalized severely. Penalizations for defect location can also be incorporated. Such a constraint would limit defect occurrence is structurally critical areas or could be used to strategically place defects such as overlaps to provide integrated stiffening. The optimization methodology presented here provides a steppingstone to further automate the decision-making during AFP process planning.

### 4D. Results and Discussion for Strut Design

### 4D.1 Transition Zone Analysis

The results of the transition zone analysis for 4 tows and 2 tows are presented in FIG. 43A and FIG. 43B, respectively. Both plots show that as the transition length increases, the ratio decreases. This represents a better predicted manufacturability as the transition length increases. It can also be seen that 2 tows are predicted to outperform 4 tows for each transition length. This is attributed to each course having to cover less of a differential in diameter when using 2 tows instead of 4.

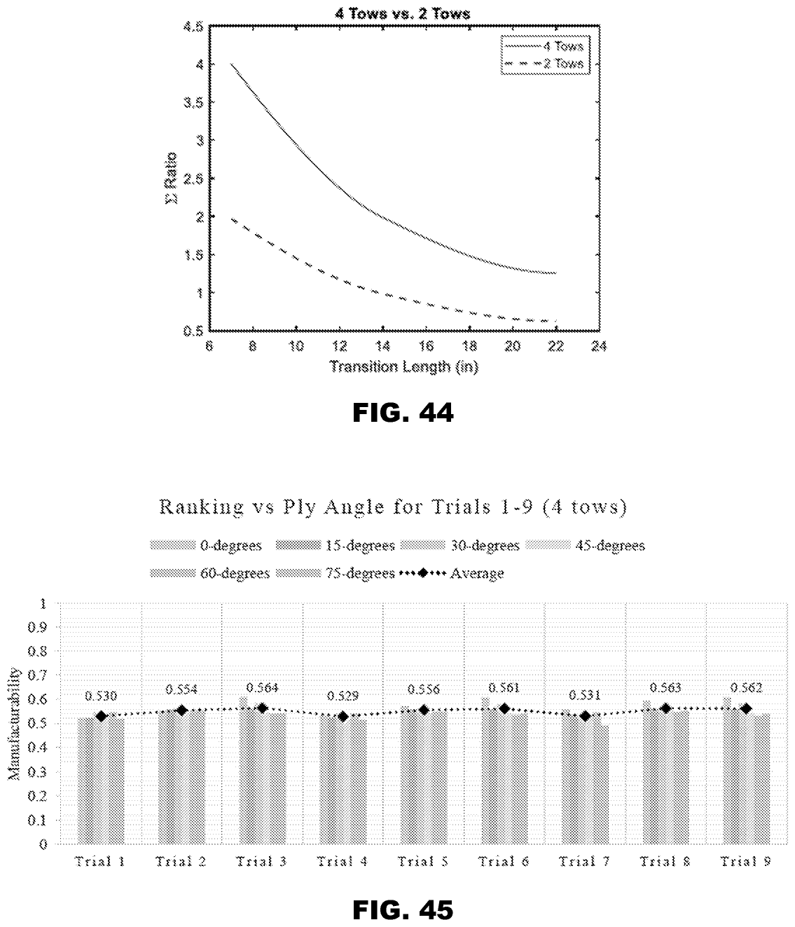

Further examination of using 4 tows versus 2 tows was performed with the results shown in FIG. 44. Again, it is seen that 2 tow trials are predicted to perform better at every transition length. This Figure also provides some insight into how the ratios change as a function of transition length. A quick improvement is seen with initial increases in transition length with depreciating results with changes in longer transition lengths.

### 4D.2 Defect Analysis

The overall manufacturability results for the 4 tow trials are shown below in FIG. 45. Each bar represents a ply's score, while the data points show the combined laminate score. Note, that the 90° plies are not included due to no defects being present for both the 4 tow and 2 tow trials. Initial observation of the figure shows little variation between each of the trials with slight increases in laminate scores as the transition length increases.

The scores of each of the ply angles presented above are summarized in Table 13. These values are averages of the 9 trials for each angle. For the 4-tow case, the 0° plies performed best while the 75° plies performed the worst. The low scores of the 75° ply are attributed to an increase in defects seen in the transition zone.

TABLE 13
Average ply scores for the 4 tow trials

| Ply Angle | Rank |
|---|---|
| 0 | 0.573 |
| 15 | 0.550 |
| 30 | 0.561 |
| 45 | 0.538 |
| 60 | 0.544 |
| 75 | 0.534 |

*4 tows

Similarly, the laminate average scores are presented in Table 14. For each radius value used, the shortest transition lengths performed the worst, while the longest transition lengths performed the best. However, the variation in scores is small and nearly negligible.

TABLE 14
Average laminate scores for the 4 tow trials

| Trial | Avg. Rank |
|---|---|
| Trial 1-4 | 0.530 |
| Trial 2-4 | 0.554 |
| Trial 3-4 | 0.564 |
| Trial 4-4 | 0.529 |
| Trial 5-4 | 0.556 |
| Trial 6-4 | 0.561 |
| Trial 7-4 | 0.531 |
| Trial 8-4 | 0.563 |
| Trial 9-4 | 0.562 |

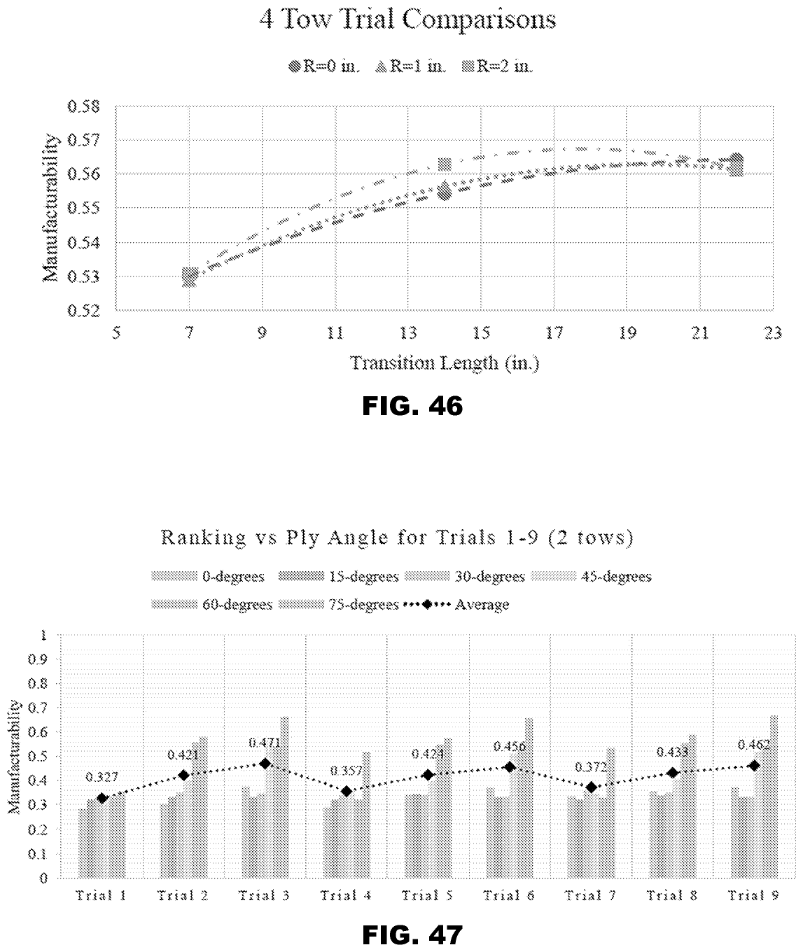

FIG. 46 below is presented to further examine the trends in how the design variables affect the manufacturability. It is seen that increasing the transition length has the largest effect on the manufacturability score. The radius values utilized have little affect regardless of which one is used, and the data is not consistent enough to draw a conclusion.

Similar results are acquired for the 2 tow trials. FIG. 47 presents a summary of the results with the ply and laminate scores shown graphically. Immediately it can be seen that all the laminate scores for the 2 tow trials are lower than those seen in the 4 tow trials. The plot also shows a larger differential when increasing the transition length.

The average scores for each ply are presented below in Table 15. Unlike the 4 tow trials, the 75° ply has the best score while the 15° ply has the worst score. However, the plies as a whole have an overall lower score than the 4 tow trials.

TABLE 15
Average ply scores for trials with 2 tows

| Ply Angle | Rank |
|---|---|
| 0 | 0.336 |
| 15 | 0.331 |
| 30 | 0.343 |
| 45 | 0.426 |
| 60 | 0.474 |
| 75 | 0.571 |

*2 tows

The overall laminate score for each of the 2 tow trials is shown below in Table 16. These values show that a lower transition length produces a lower score while the larger lengths produce a higher score. It can also be seen that there is a larger variation in the laminates with radii values of 0 and 1 than with values of 1 and 2.

TABLE 16
Average laminate scores for trials with 2 tows

| Trial | Avg. Rank |
|---|---|
| Trial 1-2 | 0.327 |
| Trial 2-2 | 0.421 |
| Trial 3-2 | 0.471 |
| Trial 4-2 | 0.357 |
| Trial 5-2 | 0.424 |
| Trial 6-2 | 0.456 |
| Trial 7-2 | 0.372 |
| Trial 8-2 | 0.433 |
| Trial 9-2 | 0.462 |

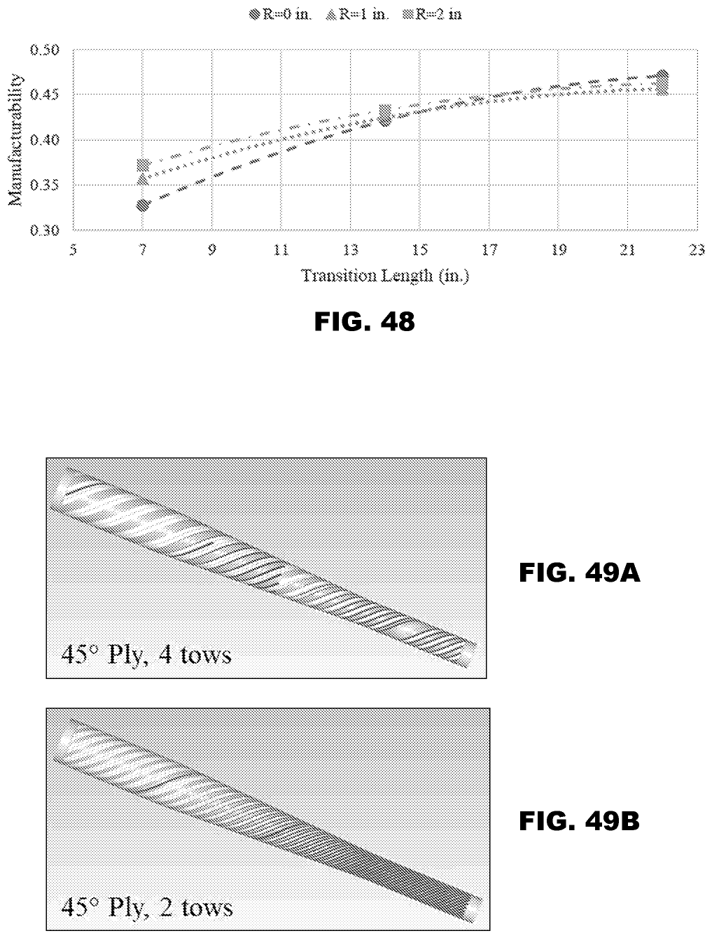

As before, the trends of the 2 tow trials are presented in FIG. 48. The results show similar trends when compared with the 4 tow trials. In both cases, increasing the transition length leads to improved overall manufacturability scores. Also, the results from varying radius values are inconclusive with initial increases in manufacturability and the opposite effect with larger transition zones.

### 4D.3 Discussion

The laminate scores from the trials presented above are combined and shown in Table 17 below. Again, all the scores from the 4 tow trials are improved when compared with those seen in the 2 tow trials. This increased score is largely due to the defects seen around the transition zone of the strut. Also, VCP checks for defects between courses therefore since more 2 tow courses are required than 4 tow courses, more zones for defects exist. Additionally, increasing the transition zone also improves the overall laminate score.

TABLE 17
Combined results for trials with 2 and 4 tows

| | Trial 1 | Trial 2 | Trial 3 | Trial 4 | Trial 5 | Trial 6 | Trial 7 | Trial8 | Trial 9 |
|---|---|---|---|---|---|---|---|---|---|
| 4 tows | 0.530 | 0.554 | 0.564 | 0.529 | 0.556 | 0.561 | 0.531 | 0.563 | 0.562 |
| 2 tows | 0.327 | 0.421 | 0.471 | 0.357 | 0.424 | 0.456 | 0.372 | 0.433 | 0.462 |

FIG. 49 below demonstrates the difference in the defects seen in the 4 tow and 2 tow trials with an example analysis of a 45° ply. When manufacturing with 4 tows, the individual defect severity may be higher; however, the instances are significantly higher when manufacturing with 2 tows. In the presented scoring method, this resulted in better score for the 4-tow case. While this scoring is valid for the given inputs, a further structural analysis examining these defects could be necessary. This analysis would provide a definite answer as to whether the lower defect occurrence with higher severity is a better option than increased defect occurrence with lower severity.

Utilizing the presented results with additional AFP manufacturing knowledge, an optimal strut geometry design can be chosen from the analyzed profiles. From analysis of the scores, the longest transition zone (20 in.) will be the best option.

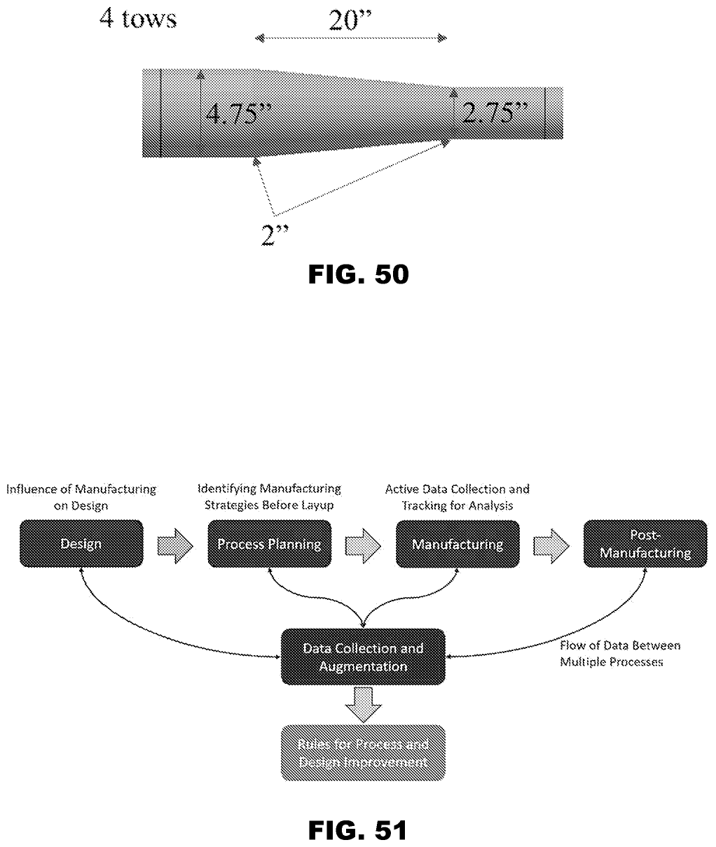

Examining the scores with the individual radii does not show a clear best option. However, it is expected that a smoother transition will result in less defects due to improved roller compression and enhanced transition smoothness. These analyses result in the best geometry being a transition length of 20 in., radii of 2 in., while manufacturing with 4 tows. The selected geometry is shown in FIG. 50 below.

### 5A. Conclusions and Future Work

The disclosure presented above represents a platform for approaching laminate optimization and defect stacking from a process planning perspective. Through creating this tool, the authors gained an increased appreciation for the complexity of studying defect stacking and determining their compounding effect on a laminate's final geometry and mechanical performance. The tool currently treats interactions between defects of the same type equally, regardless of how many plies may lie between them. Studies have shown that subsequent plies reduce the out-of-plane waviness caused by defects, so this will likely need to be incorporated by the scoring metrics. Additionally, stacked gaps tend to be filled by resin; however, this effect can be limited by intermediate plies in a different fiber direction. More research needs to be done on how defects interact with each other through the thickness of a laminate, taking into account different defect types, intermediate plies, different fiber directions, process parameters, and curing conditions. This work will help refine the scoring systems presented. Additionally, the laminate scenario creation process above constitutes one example of combinatorial optimization. There is a myriad of ways to combine ply scenarios to form a laminate scenario and future work will focus on exploring these options.

### 5B. Further Conclusions and Future Work

The presented disclosure showcases the application of SBO to AFP process planning. The surrogate models used during SBO are constructed via initial sampling and regression fitting, and optimization and infill is then used to optimize the objective function through the surrogate. The benefit of using surrogate models has been shown with improved results over other gradient free methods. The application of SBO to starting point optimization has been outlined. The functionality of the CAPP software is used to perform defect analysis and pairwise comparisons of various defect types. Multiple optimization schemes to optimize for gaps/overlaps, angle deviations, and a combination of both have been successfully implemented. The implementation highlights the complexity of selecting process planning inputs to achieve both optimal structural performance and manufacturability. The selection of such parameters is highly dependent on communication between the process planning and designer. Often engineering compromises must be made to create a structure that is manufacturable yet has appropriate performance. The optimization methodology presented shows promise to further improve process planning automation and enhance design for manufacturability.

The presented algorithms and techniques are a steppingstone where future enhancements can be made. Further iterations should be performed to select optimum inputs into the SBO. Such inputs can play a role in how effective the surrogate model is at emulating the behavior of the objective function. Other analysis methods can also be incorporated to produce a more in-depth analysis of the AFP process. Analyses such as compaction modeling of FEA techniques are good candidates; however, this will further increase the run time of the objective function. Validation of the optimization with as-manufactured data should also be accomplished. This can provide new information regarding the effectiveness of starting point and layup strategy selection. Lastly, new constraints may also be available such as the defect locations mentioned earlier. Such constraints will affect the starting point selection, as the location of the starting point will directly influence the location of defects.

### 5C. Further Discussion

We have presented an efficient toolchain for the comparison of fiber defects from various sources. The approach relies heavily on the accurate CAD representation of the tool surface, and the ability to digitally capture and predict defects and map them back to the tool surface. The digitized defects can then be discretized according to the tool surface geometry, allowing for further evaluation of the defect capture sources. The case study presented here focused on the prediction and inspection results for the overlap defect but can be expanded to other defect types relating back to tow geometry. The ply geometry and overlap prediction were performed through VCP and CAPP, and the manufactured ply was inspected with ACSIS.

The ability to accurately map and compare defect instances and severity back to the digital tool surface can greatly benefit the overall understanding of fiber defects during manufacturing and process planning. Through the understanding of the fiber defects and their origins, designers can accurately design composite structures around manufacturing capabilities. This can significantly enhance the application of AFP to larger and more complex composite structures and reduce the time from design to manufacturing.

### 5C.1 Future Work

The comparison of defects provides a two-fold benefit, where each defect detection method can be used to augment the other. Simple geometric defect detection provides the ability to identify many problematic defects before any manufacturing occurs and enables modification of ply coverage to correct for those defects. Whereas post-manufacturing inspection techniques can identify and classify defects regardless of source but requires an iterative design and manufacturing cycle to eliminate defects induced by the originally planned laminate design. The combination of these two systems could be used to more accurately predict and model defects before they appear during manufacturing trials, and the prediction of defects can be used during the training of defect inspection systems. Additionally, the comparison of defects should expand into more complex defect classes, particularly those which derive from fiber steering^{[31]}, which is a necessary process to manufacture the increasing complex structures required by industry.

### 5D. Conclusion and Future Work for Strut Design

### 5D.1 Conclusion

The investigations and developments in this study are vital to the manufacturability of struts through AFP in the future. From the analyses defined in Sections 2.1 and 2.2, it was determined a geometry with a diameter of 4.75 in. transitioning over a transition length of 20 in. to a second diameter of 2.75 in. and a transition zone initiated and terminated by a smooth transition of a 2 in. radius was the most optimized geometry (FIG. 50). It was also found that 4 tow courses produce less defects than 2 tow courses during layup. With this information and design tool, the possibility of manufacturing struts through AFP is obtainable.

### 5D.2 Future Work

Future work that needs to be conducted on this topic includes a closed loop composite product lifecycle management (PLM) tool, as shown in FIG. 51. Where, design, process planning, manufacturing, and post-manufacturing are used in unison to create the most manufacturable strut design. To increase efficiency in generating new strut geometries it is vital to have an automatic strut creation tool that eliminates the need for a modeling software. Using a system such as Python®OCC, the user could give inputs to create the surface and boundaries and decide on linear or radius geometries. Other improvements consist of surface analysis that can be used to relate expected/actual defects to surface features and process parameters. The next step is to further develop the design/analysis tool and create a link between process planning data and design variables. Continuous iteration on a single design is assumed to show improvement until some convergence is discovered.

While certain embodiments of the disclosed subject matter have been described using specific terms, such description is for illustrative purposes only, and it is to be understood that changes and variations may be made without departing from the spirit or scope of the subject matter.

What is claimed is:

1. Methodology for process planning for Automated Fiber Placement (AFP) manufacturing for identifying optimal starting point location and layup strategy for each ply of a subject laminate, for producing complex structures and large structures, comprising:
providing one or more processors programmed for conducting Computer-Aided Process Planning (CAPP), wherein said one or more processors are programmed for iteratively determining:
(1) a plurality of ply scenarios by locating respective starting points and associated layup strategies and subsequently presenting resulting geometrical fiber defect instances and severity measurements,
(2) defining the relative importance of defect types to create an overall ranking of the defect set that is used for ply level optimization, and
(3) determining final scores for each ply scenario, so that ply level defects are combined to determine optimal laminate construction that reduces the buildup of defects through the thickness of the laminate.

2. Methodology according to claim 1, wherein said one or more processors are programmed for optimizing the selection of ply scenario input parameters using surrogate-based methods.

3. Methodology according to claim 2, wherein said input parameters include at least one of starting points, layup strategies, and tows per course.

4. Methodology according to claim 2, wherein the surrogate-based methods comprise surrogate-based optimization (SBO) following the steps of:
(1) Initial sample selection,
(2) Construct surrogate model based on training data,
(3) Search surrogate model for next location of interest,
(4) Run analysis and update model at the new locations found by search, and
(5) Repeat steps (2) through (4) until a convergence criterion is met.

5. Methodology according to claim 2, wherein the surrogate-based methods include use of a regression model including one of Gaussian Process (GP), Support Vector (SV), and Random Forest (RF).

6. Methodology according to claim 2, wherein the surrogate-based methods include use of a gradient free method including use of one of (genetic algorithm (GA), particle swarm optimization (PSO), and simulated annealing (SA).

7. Methodology according to claim 1, wherein the resulting geometrical fiber defect instances and severity measurements are presented using a communication with VERICUT Composite Programming.

8. Methodology according to claim 7, wherein the geometrical fiber defect instances comprise fiber gaps, overlaps, angle deviation, and degree of steering.

9. Methodology according to claim 1, wherein the final scores are ranked for each ply scenario organized by starting point and the chosen layup strategy, chosen so that ply level defects are combined to determine the optimal laminate construction that reduces the buildup of defects through the thickness of the laminate, so that process planners create fiber paths that mitigate the number of geometry-based defects and the compounding effect they have throughout a laminate.

10. A down selection process of fiber placement strategies and seed points for Automated Fiber Placement (AFP) manufacturing in order to independently generate optimized plies to be used together for a composite structure to be AFP manufactured, the process comprising:
evaluating and predicting geometrically defined fiber defects of a plurality of possible ply geometries for use in the composite structure; and
performing an iterative optimization of the possible respective ply geometries as a function of the placement strategy and seed point, where the optimization minimizes impact of resulting fiber defects in the composite structure.

11. A process according to claim 10, wherein the geometrically defined fiber defects include at least one of fiber gaps, overlaps, angle deviation, and degree of steering.

12. A process according to claim 10, wherein the placement strategy and seed point corresponds with the starting point and the chosen layup strategy for each respective ply geometry.

13. A process according to claim 10, wherein the optimization minimizes the frequency and severity of where defects are stacking on top of each other in the composite structure.

14. A process according to claim 10, wherein defects are minimized by optimizing the selection of input parameters using surrogate-based methods.

15. A process according to claim 14, wherein defects are minimized prior to manufacture of the composite structure by optimizing the selection of at least one of starting points, layup strategies, and tows per course.

16. A process planning methodology for Automated Fiber Placement (AFP) for mitigating gap and overlap defect stacking for resulting uniform through-thickness laminate, said methodology comprising:
providing one or more processors programmed for:
using surrogate modeling optimization to search a ply level design space and capture local ply level optimums for a planned laminate; and
conducting Computer-Aided Process Planning (CAPP), for iteratively determining stacked ply level optimums.

17. A methodology according to claim 16, wherein said one or more processors are further programmed for generating a reference curve for use in ply level design of the planned laminate.

18. A methodology according to claim 17, wherein the reference curve is generated through use of one of fixed angle, geodesic, and variable angle methodologies.

19. A methodology according to claim 16, wherein said one or more processors are further programmed for conducting Computer-Aided Process Planning (CAPP) in connection with VERICUT Composite Programming (VCP).

20. A methodology according to claim 16, wherein the planned laminate comprises a strut and the determined stacked ply level optimums comprise a strut geometry optimal for limiting defects with predicted manufacturability scores.

21. A methodology according to claim 16, wherein said one or more processors are further programmed for conducting Computer-Aided Process Planning (CAPP) for further optimizing the interaction of defects between individual plies through the thickness of the laminate.

22. A methodology according to claim 16, wherein said one or more processors are further programmed for conducting Computer-Aided Process Planning (CAPP) for beginning with a laminate skeleton which defines ply boundaries and associated fiber angles.

23. A methodology according to claim 22, wherein said one or more processors are further programmed for conducting Computer-Aided Process Planning (CAPP) for planning a laminate scenario which comprises a collection of ply scenarios which respectively carry over starting point location, path geometry, and the subsequent predicted defect geometry.

24. A methodology according to claim 23, wherein said one or more processors are further programmed for conducting Computer-Aided Process Planning (CAPP) for using individual ply scores calculated during the ply optimization process to create a ply summary score, describing the average quality of the collection of ply scenarios forming the laminate scenario.

25. A methodology according to claim 24, wherein said one or more processors are further programmed for conducting Computer-Aided Process Planning (CAPP) for evaluating a plurality of respective of said laminate scenarios as a function of defect interactions from the individual plies.

26. A methodology according to claim 17, wherein said one or more processors are further programmed for conducting Computer-Aided Process Planning (CAPP) for considering the defects for all plies globally and projecting them onto a common surface.

27. A methodology according to claim 19, wherein said one or more processors are further programmed for conducting Computer-Aided Process Planning (CAPP) for predicting tow gaps, overlaps, angle deviations, and steering performed with the VERICUT Composite Programming (VCP) tool.

28. A methodology according to claim 27, wherein said one or more processors are further programmed for conducting Computer-Aided Process Planning (CAPP) for exporting resulting course to course overlaps from VCP as STEP files defining each gap and overlap instance as a unique closed contour, where fiber angle deviation and steering are defined on a regular grid over a tool surface.

29. A methodology according to claim 28, wherein said one or more processors are further programmed for conducting Computer-Aided Process Planning (CAPP) for relying on a parametric domain of the tool surface models as the basis for defect discretization, with the tool surfaces represented through non-uniform rational b-splines (NURBS).

30. A methodology according to claim 17, wherein said one or more processors are further programmed for conducting Computer-Aided Process Planning (CAPP) for identifying stacked defects throughout the entire thickness of the laminate.

31. A methodology according to claim 30, wherein said one or more processors are further programmed for conducting Computer-Aided Process Planning (CAPP) for computing defect interactions beginning from the base ply and updating the levels of defect interaction as additional plies are considered.

32. A methodology according to claim 30, wherein said one or more processors are further programmed for conducting Computer-Aided Process Planning (CAPP) for measuring and scoring stacked defects relying on determined defect levels.

33. A methodology according to claim 32, wherein said one or more processors are further programmed for conducting Computer-Aided Process Planning (CAPP) for creating a frequency score, to describe the total stacked defect area above a chosen threshold in comparison to the total defect area, calculated as
$$Frequency = 1 - \frac{{\sum }_{threshold}^{{n}_{levels}} {A}_{level}}{{\sum }_{0}^{{n}_{levels}} {A}_{level}}$$
where nₗₑᵥₑₗₛ is the total number of defect levels in the laminate and Aₗₑᵥₑₗ is the area of the level.

34. A methodology according to claim 33, wherein said one or more processors are further programmed for conducting Computer-Aided Process Planning (CAPP) for creating a severity to compare defect levels above the chosen threshold to total defect level area, calculated as:
$$Severity = 1 - \frac{{\sum }_{threshold}^{{n}_{levels}} {( Level - Threshold + 1 )}^{2} * {A}_{level}}{{\sum }_{0}^{{n}_{levels}} ( Level + 1 ) * {A}_{level}} .$$

35. A methodology according to claim 34, wherein said one or more processors are further programmed for conducting Computer-Aided Process Planning (CAPP) for calculating a single score that combines frequency and severity of each defect through use of an analytic hierarchy process (AHP) matrix.

36. A methodology according to claim 35, wherein said one or more processors are further programmed for conducting Computer-Aided Process Planning (CAPP) for converting the matrix into rankings used to compute the score of each scenario, based on user selected relative values within the matrix designated per the user's relative priorities for certain defects.

37. A methodology according to claim 36, wherein said one or more processors are further programmed for conducting Computer-Aided Process Planning (CAPP) for computing individual scenario scores, calculated as:
Score=Σ Ranking Weight*Measurement Value

38. A methodology according to claim 37, wherein said one or more processors are further programmed for conducting Computer-Aided Process Planning (CAPP) for computing manufacturability for the entire laminate as a function of the size of each ply, where the score is the maximum score from all scenarios in the associated ply, the manufacturability calculated as:
$$Manufacturability = {\sum }_{n = 1}^{\# plies} {Score}_{n} * Ply {Area}_{n} / {\sum }_{m = 1}^{\# plies} Ply {Area}_{m}$$
here a manufacturability score of 1 is the highest possible value and 0 is the lowest.
